(19) United States
(12) Patent Application Publication
(10) Pub. No.: US 2015/0347295 A1
(43) Pub. Date: Dec. 3, 2015

(54) METHOD OF OPERATING A MEMORY SYSTEM USING A GARBAGE COLLECTION OPERATION

(71) Applicants: DongHyuk IHM, Hwaseong-si (KR); Chonghyun LEE, Seoul (KR)

(72) Inventors: DongHyuk IHM, Hwaseong-si (KR); Chonghyun LEE, Seoul (KR)

(21) Appl. No.: 14/711,016

(22) Filed: May 13, 2015

(30) Foreign Application Priority Data
Jun. 2, 2014 (KR) 10-2014-0066998

(51) Int. Cl. G06F 12/02

(52) U.S. Cl. CPC G06F 12/0253; G06F 12/0246; G06F 2212/7201; G06F 2212/7205

(57) ABSTRACT

A memory system may include a nonvolatile memory including a plurality of memory blocks; and a memory controller including a garbage collection unit, the garbage collection unit configured to generate a garbage collection level, the garbage collection unit configured to perform a garbage collection operation based on the garbage collection level and a garbage collection trigger level, and the garbage collection level being generated based on a free block generation time of the nonvolatile memory.

### CROSS-REFERENCE TO RELATED APPLICATION

This U.S. non-provisional patent application claims priority under 35 USC §119 to Korean Patent Application No. 10-2014-0066998 filed on Jun. 2, 2014, in the Korean Intellectual Property Office (KIPO), the entire contents of which is hereby incorporated by reference herein.

### BACKGROUND

At least some embodiments of the inventive concepts relate generally to memory systems, memory devices, and methods of operating a memory system, and more particularly to methods of operating a memory system including a nonvolatile memory device, wherein a garbage collection operation is used to move data from an invalid data block to valid data block of the nonvolatile memory device.

Memory systems including one or more nonvolatile semiconductor memory devices have become staple components in contemporary consumer electronic products. A variety of nonvolatile semiconductor memory devices are known, including as examples, the electrically erasable programmable read only memory (EEPROM), the phase-change random access memory (PRAM), the magnetic random access memory (MRAM), and the resistance read only memory (ReRAM). Within the broad class of nonvolatile semiconductor memory devices, flash memory provides certain advantages such as rapid reading speed, low power consumption, very dense data storage capacity, etc. As a result, many contemporary memory systems incorporated in contemporary digital computational platforms and consumer electronics include flash memory as a data storage medium.

In an nonvolatile memory device, data stored in nonvolatile memory is performed periodically garbage collection operation to improve storage capacity of the nonvolatile memory. Namely, the garbage collection operation is to copy valid pages in a block which includes invalid pages and valid pages to another block, and erase the block which includes the invalid pages. The erased block is a free block.

Nonvolatile memory device executes read operation or write operation in response to the read or write request. When the nonvolatile memory device is insufficient free block to execute write operation, garbage operation is needed to perform before the write operation. This arises delay of response time with respect to the write operation. User may recognize reduced performance of the nonvolatile memory device.

### SUMMARY

At least some embodiments of the inventive concepts provide memory system and operation method including a garbage collection unit to improve response time of read operation or write operation by executing the garbage collection operation in idle time.

According to one or more example embodiments of the inventive concepts, a memory system may include a nonvolatile memory including a plurality of memory blocks; and a memory controller including a garbage collection unit, the garbage collection unit configured to generate a garbage collection level, the garbage collection unit configured to perform a garbage collection operation based on the garbage collection level and a garbage collection trigger level, and the garbage collection level being generated based on a free block generation time of the nonvolatile memory.

The free block generation time of the nonvolatile memory may be an average free block generation time or a maximum free block generation time.

The memory controller may be configured to determine a valid page group of each of the plurality of memory blocks according to a number of valid pages of each of the plurality of the memory blocks, the memory controller may be configured to determine free block generation times of at least two of the valid page groups, and the memory controller may be configured to generate the garbage collection level based on the determined free block generation times.

The memory controller may be configured to determine the average free block generation time based on the free block generation times of each of the valid page groups, and the memory controller may be configured to determine the garbage collection level of the nonvolatile memory using the determine average free block generation time.

The memory controller may include a random access memory (RAM) unit, the memory controller may be configured to store, in the RAM unit, the number of valid pages of each of the plurality of memory blocks, the valid page group of each of the plurality of the memory blocks, the average free block generation time of the nonvolatile memory, and the garbage collection level of the nonvolatile memory.

The memory controller may be configured to determine the maximum free block generation time using the free block generation times of each of the at least two of the valid page groups, and the memory controller may be configured to determine the garbage collection level of the nonvolatile memory based on the determined maximum free block generation time, where the maximum free block generation time indicates a length of time for generating free blocks of a maximum free block count.

The memory controller may be configured to store the valid page group each of the plurality of memory blocks, the number of valid pages of each of the plurality of memory blocks, the memory controller is configured to store the maximum free block generation time of the nonvolatile memory, and the garbage collection level of the nonvolatile memory.

The garbage collection unit may be configured to generate one or more free blocks by performing the garbage collection operation, the garbage collection unit may be configured to change a value of a free block count based on a total number of the generated one or more free blocks, and the garbage collection unit may be configured to terminate the garbage collection operation based on the changed value of the free block count and a maximum free block count.

The garbage collection unit may be configured to terminate the garbage collection operation in response to determining that the changed value of the free block count is greater than or equal to the maximum free block count.

The garbage collection unit may be configured to generate the garbage collection level in response to determining that idle time of the nonvolatile memory is greater than a reference idle time.

The garbage collection unit may be configured to generate the garbage collection level if data storage space is below a reference storage space level.

According to one or more example embodiments of the inventive concepts, a memory system includes a nonvolatile memory including a plurality of memory blocks; and a memory controller including a garbage collection unit, the garbage collection unit being configured to, select, from among a plurality of garbage collection levels, a garbage collection level of the nonvolatile memory based on free block generation times of the plurality of blocks, the free block generation times indicating time lengths of free block generation operations for generating free blocks among the plurality of memory blocks, and determine whether or not to perform a garbage collection operation on the nonvolatile memory based on the selected garbage collection level and a garbage collection trigger level.

The plurality of garbage collection levels may correspond, respectively, with a plurality of threshold times, and the garbage collection unit may be configured to select the garbage collection level of the nonvolatile memory by determining an average free block generation time based on the free block generation times of the plurality of blocks, and selecting the garbage collection level of the nonvolatile memory, from among the plurality of garbage collection levels, based on the average free block generation time and the plurality of threshold times.

The garbage collection unit may be configured to determine the average free block generation time as an average amount of time to generate one free block among the plurality of memory blocks.

The garbage collection unit may be configured to determine the average free block generation time as an average amount of time to generate n free blocks among the plurality of memory blocks, n being a positive integer equal to a maximum free block number of the memory system, the maximum free block number being a maximum number of free blocks the memory system is capable of generating in a garbage collection operation.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram illustrating a memory system according to at least one embodiment of inventive concepts.

FIG. 2 is a block diagram further illustrating in one example the memory controller of FIG. 1.

FIG. 3 is a block diagram further illustrating in another example the memory controller of FIG. 1.

FIG. 4 is a block diagram further illustrating in one example the memory device of FIG. 1.

FIG. 5 is a perspective view illustrating one example three-dimensional structure for the memory cell array illustrated in FIG. 4.

FIG. 6 is an equivalent circuit diagram for the partial memory cell array structure shown in FIG. 5.

FIG. 7 is a conceptual diagram illustrating in one example a method of operating the memory system that includes executing a garbage collection operation according to at least some embodiments of the inventive concepts.

FIG. 8A and FIG. 8B are graphs illustrating relation between latency of the memory device of FIG. 1 and garbage collection operation.

FIG. 9 is a flow chart illustrating an operation of the garbage collection unit of FIG. 1 according to at least some example embodiments of the inventive concepts.

FIG. 10 and FIG. 11 are flowcharts illustrating operations that the garbage collection unit performs to generate the garbage collection level according to at least some example embodiments of the inventive concepts.

FIG. 12 is a conceptual diagram illustrating the garbage collection operation according to at least some example embodiments of the inventive concepts.

FIG. 13 is a graph illustrating a composition of garbage collection information including valid page number, valid page group, and free block generation time of the each memory blocks according to at least some example embodiments of the inventive concepts.

FIG. 14, FIG. 15, and FIG. 16 illustrate the operation of the garbage collection unit of FIG. 2 and FIG. 3 according to at least some example embodiments of the inventive concepts.

FIG. 17, FIG. 18 and FIG. 19 are additional examples illustrating an operation of the garbage collection unit in FIG. 2 and FIG. 3 according to at least some example embodiments of the inventive concepts.

FIG. 20, FIG. 21, and FIG. 22 are additional examples illustrating operations of the garbage collection unit of FIG. 2 and FIG. 3 according to at least some example embodiments of the inventive concepts.

FIG. 23, FIG. 24, and FIG. 25 are additional examples illustrating operations of the garbage collection unit of FIG. 2 and FIG. 3 according to at least some example embodiments of the inventive concepts.

FIG. 26 and FIG. 27 are block diagrams respectively illustrating example applications of a memory system according to at least one example embodiment of the inventive concepts.

FIG. 28 is a block diagram illustrating a memory card system 3000 that may incorporate a memory system according to at least one example embodiment of the inventive concepts.

FIG. 29 is a block diagram illustrating a solid state drive (SSD) system including a memory system according to at least one example embodiment of the inventive concepts.

FIG. 30 is a block diagram further illustrating the SSD controller 4210 of FIG. 29.

FIG. 31 is a block diagram illustrating an electronic device that may incorporate a memory system according to at least one example embodiment of the inventive concepts.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Unless otherwise defined, all terms, including technical and scientific terms, used herein have the same meaning as commonly understood by one of ordinary skill in the art to which example at least some embodiments of the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### I. Memory System Including a Garbage Collection Unit

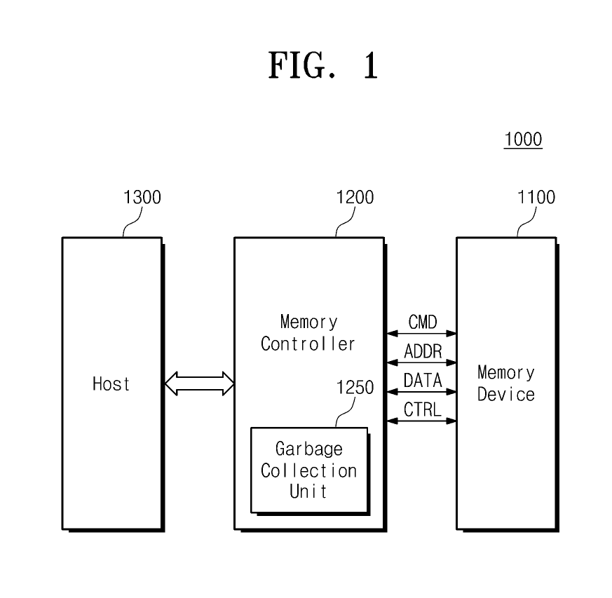

FIG. 1 is a block diagram illustrating a memory system according to at least one embodiment of inventive concepts. Referring to FIG. 1, a memory system 1000 comprises a memory device 1100, a memory controller 1200 and host 1300.

The memory device 1100 will be operationally controlled by the memory controller 1200 to perform a sequence of variously defined “operations” in response to one or more requests, commands, and/or instructions received from the host 1300. Operations performed by the memory device 1100 under the control of the memory controller 1200 may vary in definition between different implementations of the memory system 1000, but will typically include at least read, write (i.e., program), and/or erase operations, as well as certain housekeeping operations necessary to the efficient overall performance of the memory system 1000. The memory device 1100 may include a plurality of memory blocks.

The memory controller 1200 is functionally connected between the memory device 1100 and the host 1300. The memory controller 1200 will control read and/or write operation of the memory device 1100 in response to requests of the host 1300. The memory controller 1200 may be used to receive host-defined data (e.g., write data or incoming data, generally designated “Data_h”), and to receive memory device-defined data (e.g., read data retrieved from the memory device 1100 during a read or similar operation, generally designated “DATA”).

In addition to controlling exchanges of various data between the host 1300 and memory device 1100, the memory controller 1200 may also be used to generate and communicate various command information (CMD) and address information (ADDR) related to the exchange of various data, as well as one or more control signals (CTRL) to the memory device 1100.

In the illustrated embodiment of FIG. 1, the memory controller 1200 comprised a garbage collection unit 1250. The garbage collection unit 1250 may be variously implemented using hardware, firmware and/or software components provided by the memory controller 1200. However configured, the garbage collection unit 1250 may be used to define and control the execution of a “garbage collection operation” by the memory device 1100. Garbage collection operations may be defined differently in different memory systems, but however defined, a garbage collection operation will be capable of collecting valid data of the memory device 1100, and erasing invalid data of the memory device 1100.

Further, in response to the execution of a garbage collection operation by the memory device 1100, the garbage collection unit 1250 will manage garbage collection information including a number of valid page of memory block, a number of valid page groups of a memory block, free block generation time, a garbage collection level, and a garbage collection trigger level.

In at least the example embodiment of the inventive concepts illustrated in FIG. 1, the memory system 1000 may perform a garbage collection operation in the idle time of memory device 1100. According to the inventive concepts, the memory system 1000 may perform a garbage collection operation when garbage collection efficiency is high by considering the valid page ratio of the memory device 1100. According to at least some example embodiments of the inventive concepts, the memory system 1000 improves response time of read or write operation, and extends life of the memory device 1100 in comparison with conventional systems.

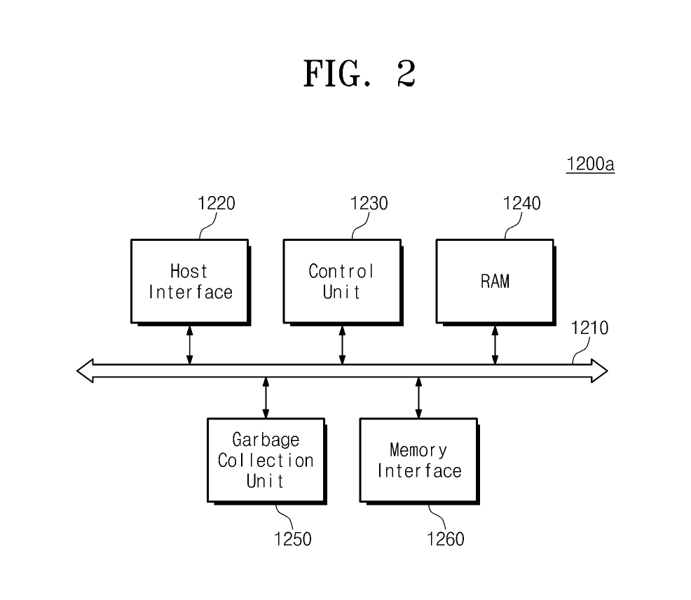

FIG. 2 is a block diagram further illustrating in one example (1200a) the memory controller 1200 of FIG. 1. Referring to FIG. 2, the memory controller 1200a comprises in relevant part: a system bus 1210, a host interface 1220, control unit 1230, a Random Access Memory (RAM) 1240, the garbage collection unit 1250, and a memory interface 1260.

The system bus 1210 generally provides a connection channel between the various elements of the memory controller 1200a noted above.

The host interface 1220 may be used to enable communication with the host 1300 using one or more conventionally understood communication standard(s). For example, the host interface 1220 may enable one or more communication standards, such as Universal Serial Bus (USB), Peripheral Component Interconnection (PCI), PCI-express (PCI-E), Advanced Technology Attachment (ATA), Serial-ATA, Parallel-ATA, Small Computer Small Interface (SCSI), Enhanced Small Disk Interface (ESDI), Integrated Drive Electronics (IDE), fire-wire, etc.

The control unit 1230 may be used to receive host-defined data (Data_h) as well as related command and address information from the host 1300, and to control the overall operation of the memory controller 1200.

The RAM 1240 may be used to cache or buffer memory to temporarily store, for example, data (e.g., Data_h and/or DATA), command information, address information, computational information, and other types of data and/or information necessary to the functionality of the memory controller 1200.

As described above in relation to FIG. 1, the garbage collection unit 1250 may control the execution of garbage collection operation(s) by the memory device 1100, and may control the generation and storing of the garbage collection information. The operating principles of a competent garbage collection unit in the context of at least some example embodiments of the inventive concepts will be described in some additional detail below.

The memory interface 1260 may be used to enable communication of data between the memory controller 1200 and the memory device 1100. For example, the memory interface 1260 may be a NAND type flash memory interface, or a vertical NAND (VNAND) type flash memory interface, etc.

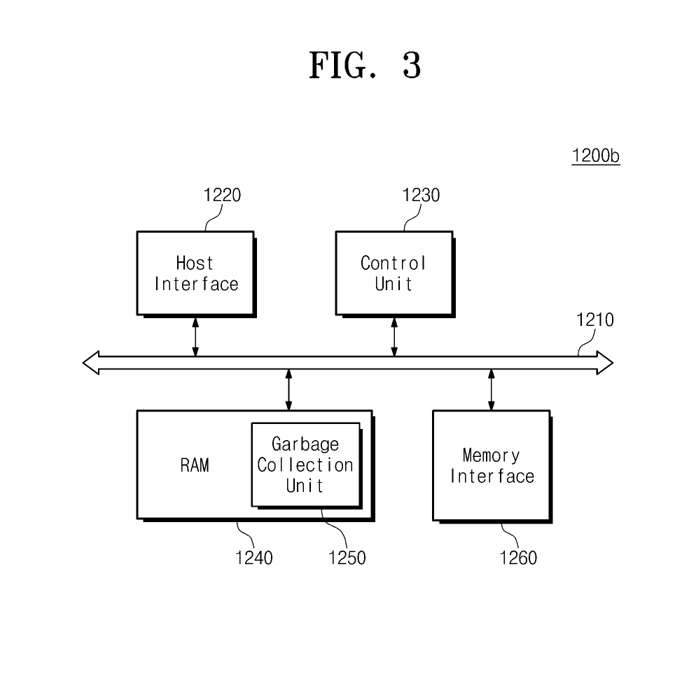

FIG. 3 is a block diagram further illustrating in another example (1200b) of the memory controller 1200 of FIG. 1. The elements described in relation to the memory controller 1200a of FIG. 2 are respectively the same as those shown in FIG. 3, except that certain software components used to implement the garbage collection unit 1250 are shown as being specifically stored by the RAM 1240 during operation of the memory controller 1200b.

The memory device according to at least one example embodiment of the inventive concepts, may be applied not only to a 2-dimensional structure flash memory but also a 3-dimensional structure flash memory 3D Flash memory.

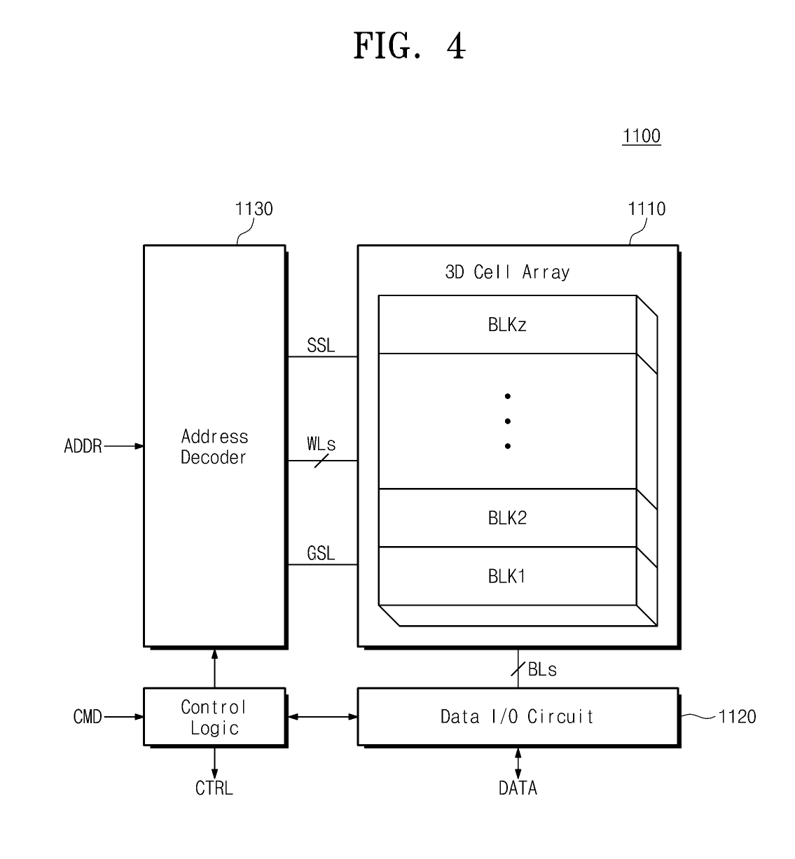

FIG. 4 is a block diagram further illustrating in one example the memory device 1100 being implemented, wholly or in part, to include a three-dimensional (3D) flash memory. Thus, referring to FIG. 4, the memory device 1110 comprises a 3D flash memory cell array 1110, a data input/output (I/O) circuit 1120, an address decoder 1130, and control logic 1140.

The 3D flash memory cell array 1110 is also logically and/or physically partitioned into a plurality of memory blocks (BLK1 to BLKz), wherein each memory block has a three-dimensional (or vertical) structure. Each memory block being an erasable unit for the memory device 1100.

The data I/O circuit 1120 may be used to functionally connect a plurality of bit lines extending across the 3D flash memory cell array 1110 to various external circuits. In this configuration, the data I/O circuit 1120 may be used to receive write data (or encoded write data), and may also be alternately used to receive read data retrieved from the 3D flash memory cell array 1110.

The address decoder 1130 may be used to functionally connect a plurality of word lines as well as at least one ground selection line GSL and string selection line SSL extending across the 3D flash memory cell array 1110 to various external circuits. In this configuration, the address decoder 1130 may be used to select one or more word lines in response to received address information ADDR.

The control logic 1140 may be used to control the overall execution of at least write (program), read, erase, and garbage collection operations by the memory device 1100. That is, the control logic 1140 may be used to control operation of the address decoder 1130 such that a specified program voltage is applied to a selected word line during a program operation, and to further control the data I/O circuit 1120 to receive and hold write data to be programmed during the program operation.

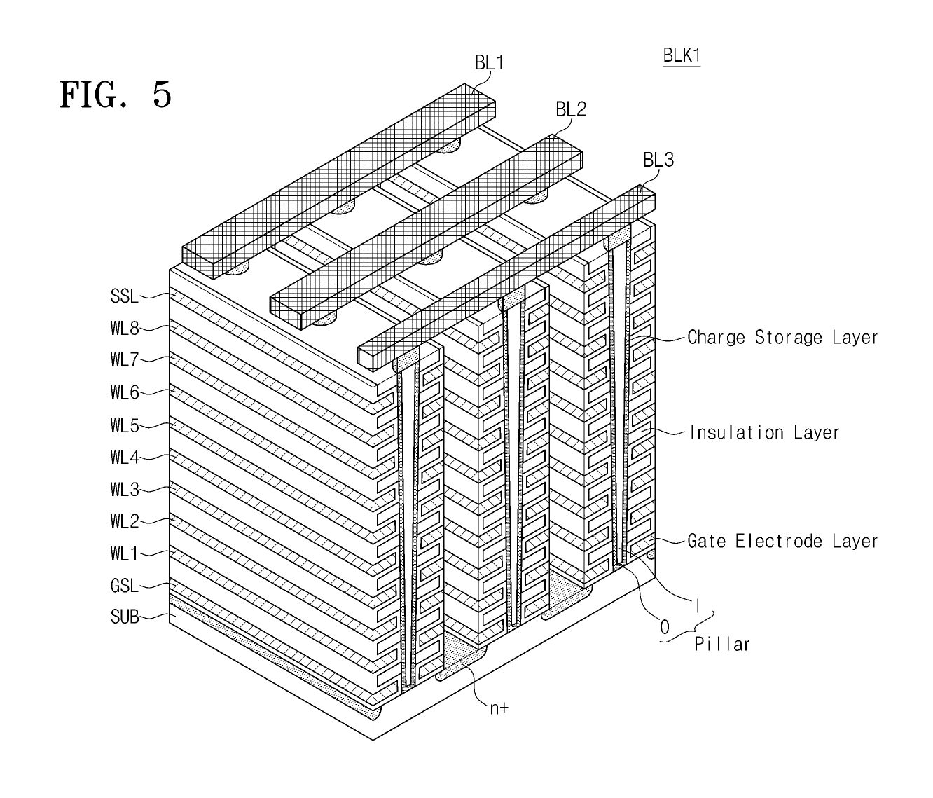

FIG. 5 is a perspective view illustrating in one example a portion of a 3D flash memory array corresponding to a first memory block (BLK1) shown in FIG. 4. Referring to FIG. 5, the first memory block, as an example of similarly configured memory blocks, is formed in a direction perpendicular to a principal substrate SUB. An n+ doping region is selectively formed in the substrate. A gate electrode layer and an insulation layer are then sequentially deposited on the substrate. A gate electrode layer and an insulation layer are then sequentially deposited on the substrate. A charge storage layer is formed between the gate electrode layer and the insulation layer.

If the gate electrode layer and the insulation layer are patterned in a vertical direction, a V-shaped pillar is formed. The pillar may thus be connected with the substrate via the gate electrode layer and the insulation layer.

An outer portion ‘O’ of the pillar forms a semiconductor channel, while an inner portion ‘I’ forms an insulation material (e.g., silicon oxide) around the semiconductor channel.

The gate electrode layer of the memory block BLK1 is connected to a ground selection line GSL, a plurality of word lines WL1 to WL8, and a string selection line SSL. In this manner, the pillar BLK1 is connected with a plurality of bit lines BL1 to BL3. FIG. 5 illustrates an example in which one memory block BLK1 has two (2) ground/string selection lines and eight (8) word lines WL1 to WL8.

However, at least some embodiments of the inventive concepts may have many different signal line definitions.

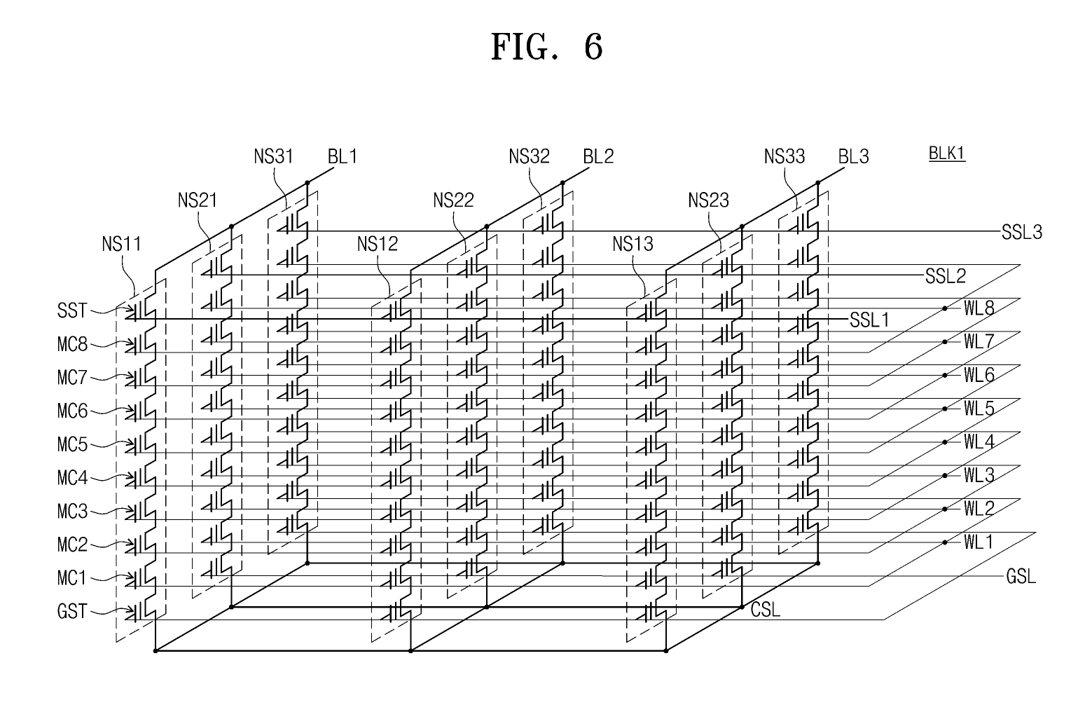

FIG. 6 is an equivalent circuit diagram for the first memory block BLK1 shown in FIG. 5. Referring FIG. 6, NAND strings NS11 to NS33 are connected between it lines BL1 to BL3 and a common source line CLS. Each NAND string (e.g., NS110) includes a string selection transistor SST, a plurality of memory cells MC1 to MC8, and a ground selection transistor GST.

The string selection transistor SST may be connected with string selection lines SSL1 to SSL3. The memory cells MC1 to MC8 may be connected with corresponding word lines WL1 to WL8, respectively. The ground selection transistor GST may be connected with ground selection lines GSL1 to GSL3. A string selection transistor SST may be connected with a bit lines, and a ground selection transistor GST may be connected with a common source line CLS.

Word lines (e.g., WL1) having the same height may be commonly connected, and the ground selection lines GSL1 to GLS3 and the string selection lines SSL1 to SSL3 may be separated from one from another. During programming of the constituent memory cells of a designated “page” connected to a first word line WL1 and included in NAND strings NS11, NS12, and NS13, a first word line WL1, a first string selection line SSL1, and a first ground selection line will be selected by the various control circuits.

### II. Method of Operation the Memory System Including a Garbage Collection Unit

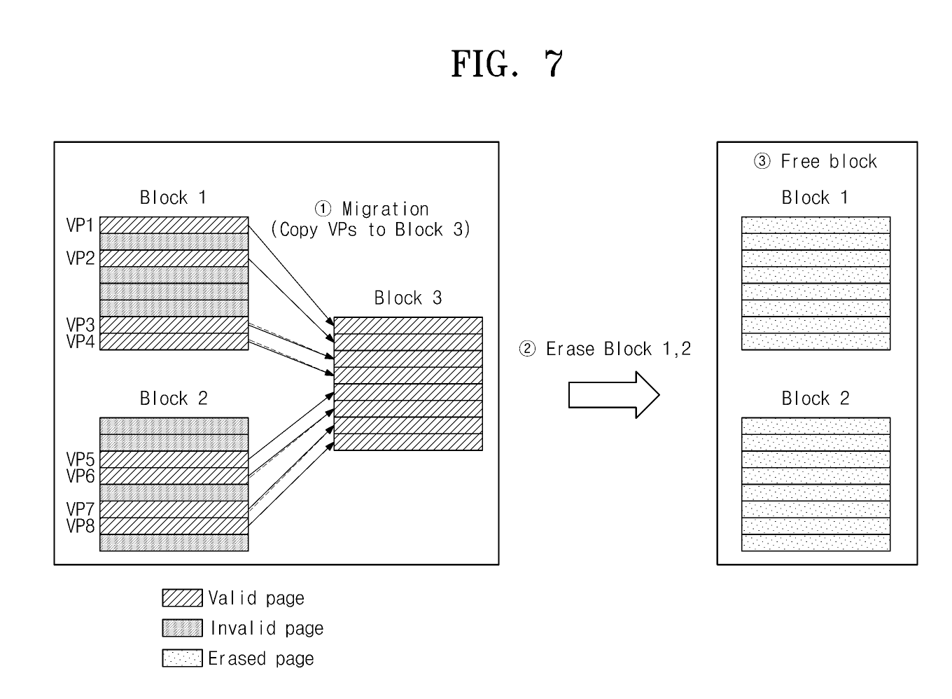

FIG. 7 is a concept diagram illustrating in one example the execution of a garbage collection operation using garbage collection unit of the memory system of FIG. 1 in relation to collecting data of valid page (VP), erasing invalid page such that the garbage collection unit generates free block (FB).

Referring to FIG. 7, the garbage collection unit 1250 may perform a garbage collection operation when idle time of the memory device 1100 is longer than a reference idle time. The garbage collection unit 1250 may perform a garbage collection operation when space for storing data in the memory device 1100 or a number of free blocks are insufficient. The memory system 1000 of FIG. 1 including a flash memory may perform garbage collection operation for effectively controlling file data and improving system performance.

Still referring to FIG. 7, the memory system 1000 stores data to the first and second memory blocks (Block 1, Block 2). The memory blocks storing the data may be data blocks. One or more valid pages (VP) of the first and/or second data blocks (Block 1, Block 2) may become invalid according to a state of the memory system 1000 as time goes by.

If an invalid page is generated in the data blocks (e.g., Block 1, Block 2), the garbage collection unit 1250 of the memory controller 1200 is capable of collecting the valid pages (VP 1˜VP 8) of the first and/or second data blocks, and programming the collected valid pages to the third memory block (Block 3) (\textcircled{1}). Here, the third memory block (Block 3) into which the collected data is copied may be a new data block.

Upon completion of the programming, the garbage collection unit 1250 may erase the first and the second data blocks (\textcircled{2}). The garbage collection unit 1250 may classify the erased memory blocks as free blocks (Block 1, Block 2) (\textcircled{3}). The generated free blocks (Block 1, Block 2) may be used to program data transmitted from the host 1300. The garbage collection unit 1250 executes garbage collection operation performed by the above described step (\textcircled{1}˜\textcircled{3}).

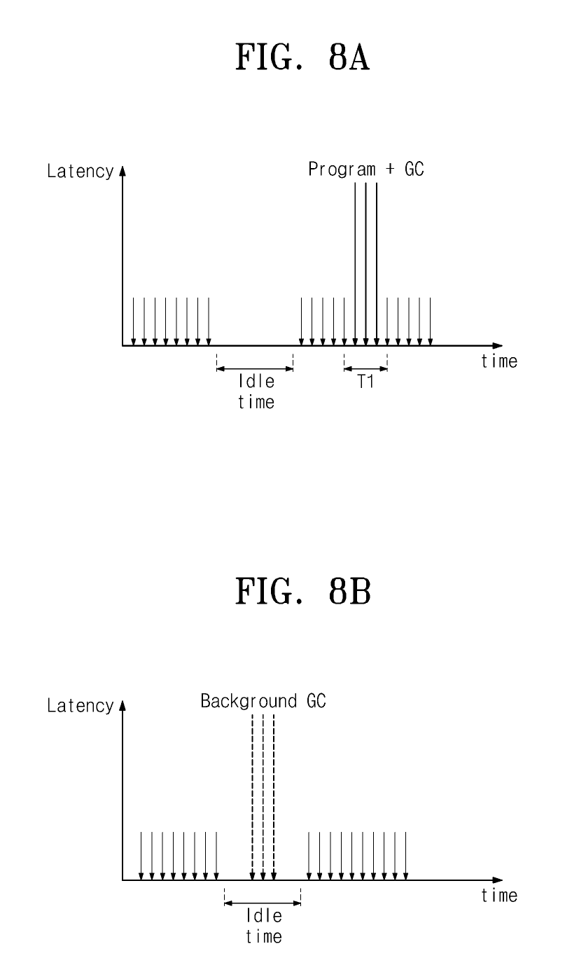

FIG. 8A and FIG. 8B are graphs illustrating relation between latency of the memory device of FIG. 1 and garbage collection operation. In the FIGS. 8A and 8B, the horizontal axis is a time and the vertical axis is latency of the memory device 1100 of FIG. 1. The “latency” is time that the memory device 1100 executes read or write (program or erase) operation.

Referring to FIG. 8A, the memory device 1100 performs the received program command during T1 time period. When space to store program data is insufficient, the memory device 1100 executes a program operation and the garbage collection operation. If program and garbage collection operations are performed simultaneously, the latency of the memory device 1100 increases.

Referring to FIG. 8B, the memory device 1100 executes garbage collection operation during idle time such that the memory device 1100 generates free block storing program data when performing occurred program operation since then. Thus, executing the garbage collection operation during idle time may prevent latency of the memory device 1100 from increasing during read or program operation of the memory device 1100.

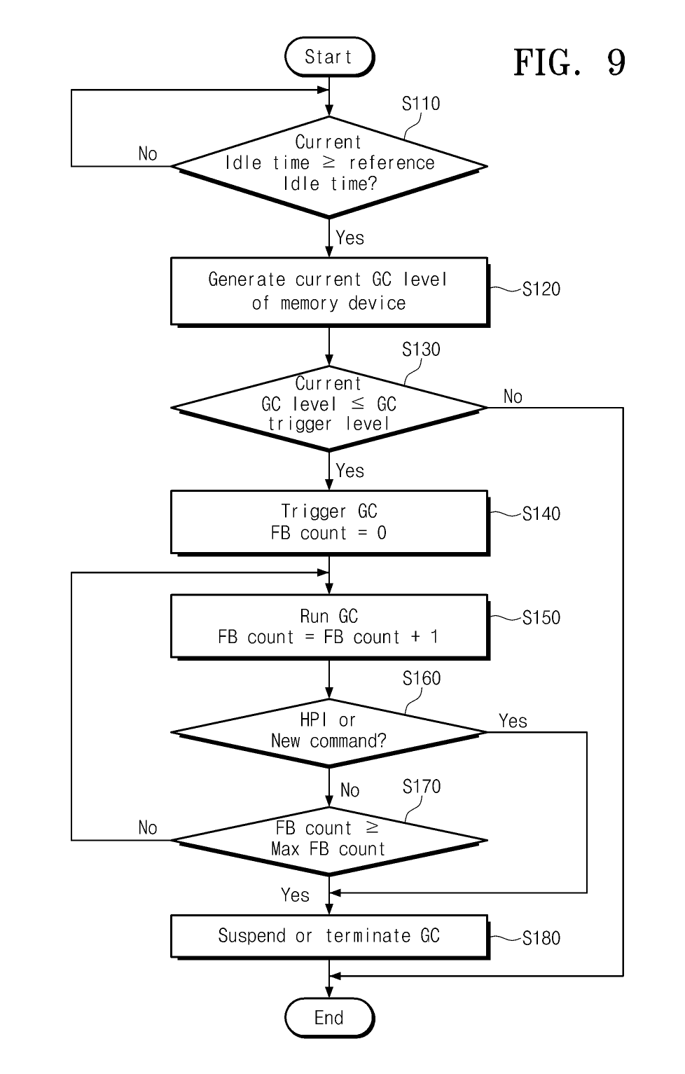

FIG. 9 is a flow chart illustrating an operation of the garbage collection unit of FIG. 1.

In step S110, the garbage collection unit 1250 determines whether or not current idle time of the memory device 1110 is longer than or equal to the reference idle time. Here, the current idle time of the memory device 1100 refers to the amount of time that idle state of the memory device 1100 lasts. The reference idle time may be a predetermined or, alternatively, desired value that is, according to at least some example embodiments, stored in the memory device 1100. The reference idle time may be changed according to the operation of the memory system 1000.

If the current idle time of the memory device 1100 is longer than or equal to the reference idle time, the garbage collection unit 1250 executes S120 step. If the current idle time of the memory device 1100 is shorter than the reference idle time, the garbage collection unit 1250 returns to step S110 such that the garbage collection unit 1250 continuously checks the current idle time of the memory device 1100.

In step S120, the garbage collection unit 1250 generates current garbage collection level (current GC level) of the memory device 1100. The garbage collection level may be generated on the basis of an amount of time it takes to generate the first and second free block (reference to FIG. 7). The generating time of the first and second free block may be calculated using the number of valid pages in the first and second memory block (reference FIG. 7) prior to the generation of the first and second free blocks.

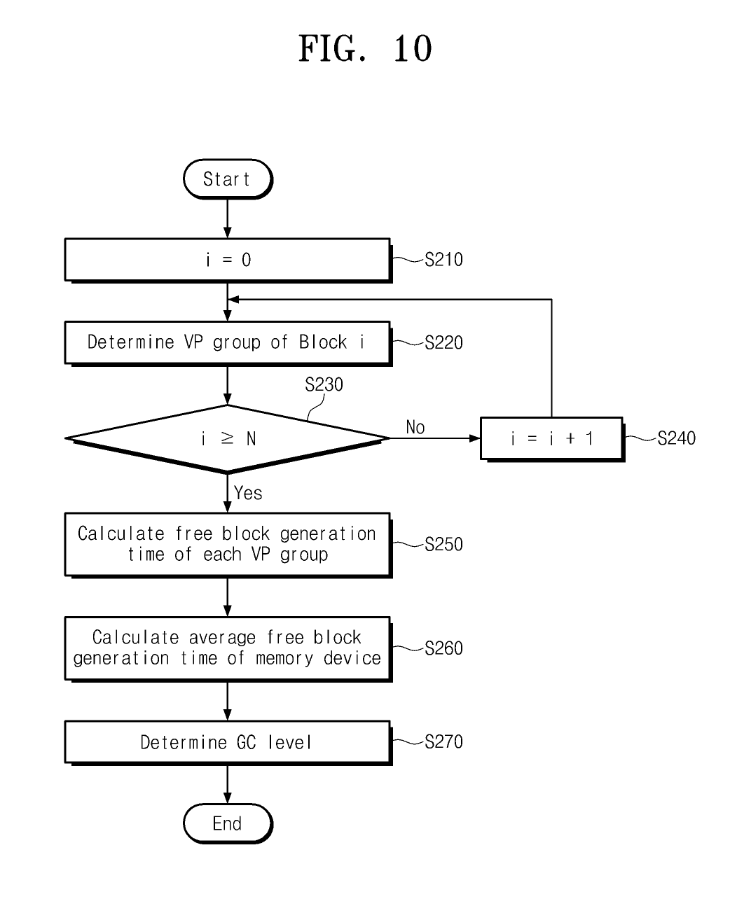

The garbage collection level may be generated on the basis of an average free block generating time. The average free block generating time is an average time that it takes to generate the first and second free blocks. The average free block generating time may be calculated using the number of valid pages of the first and second memory blocks (reference FIG. 7). A method by which the garbage collection unit 1250 generates a garbage collection level will be described in some additional detail with reference to FIG. 10.

In step S130, the garbage collection unit 1250 determines whether or not the current garbage collection level is less than or equal to a garbage collection trigger level. The garbage collection unit 1250 uses the garbage collection trigger level as a reference value to determine whether to perform garbage collection of the memory device 1100.

The garbage collection trigger level may be a predetermined or, alternatively, desired value. The garbage collection trigger level may be changed according to an operation of the memory controller 1200. The garbage collection unit 1250 executes step S140 when the current garbage collection level (current GC level) is less than or equal to the garbage collection trigger level (GC trigger level). The garbage collection unit 1250 terminates the operation without executing the garbage collection operation when the current garbage collection level is greater than the garbage collection trigger level.

In step S140, the garbage collection unit 1250 may trigger the garbage collection operation of the memory device 1100. Here, the garbage collection unit 1250 initiates a free block count (FB count) with ‘0’.

In step S150, the garbage collection unit 1250 executes a garbage collection operation of the memory device 1100. The garbage collection unit 1250 increases a value of the free block count when the free block is generated during execution of the garbage collection operation.

In step S160, the garbage collection unit 1250 determines whether or not a high priority input (HPI) or new command (CMD) is received at the memory controller 1200. The high priority input (HPI) may be a command regarding to an operation having a high priority to be performed with terminating executing operation. The garbage collection unit 1250

The garbage collection unit 1250 executes step S180, thereby terminating the garbage collection operation, when the memory controller 1200 receives high priority input or new command. The garbage collection unit 1250 executes step S170 if the memory controller 1200 does not receive HPI or new command.

In step S170, the garbage collection unit 1250 determines whether or not the free block count is greater than or equal to a maximum free block count (Max FB count). The maximum free block count is the maximum number of free blocks generated during the garbage collection operation. The maximum free block count value may be a predetermined or, alternatively, desired value. The garbage collection unit 1250 may change the maximum free block count value according to an operation condition of the memory system 1000.

The garbage collection unit 1250 executes step S180 to terminate the garbage collection operation when the free block count value is greater than or equal to the maximum free block count value. The garbage collection unit 1250 executes step S150 when the free block count value is less than the maximum free block count value. In step S180, the garbage collection unit 1250 terminates or suspends the garbage collection operation

Referring to FIG. 9, the garbage collection unit 1250 generates the garbage collection level, compares the garbage collection level with the garbage collection trigger level, and executes the garbage collection operation based on a result of the comparison and the garbage collection level. The garbage collection level may be generated on the basis of the free block generating time of the memory device 1100.

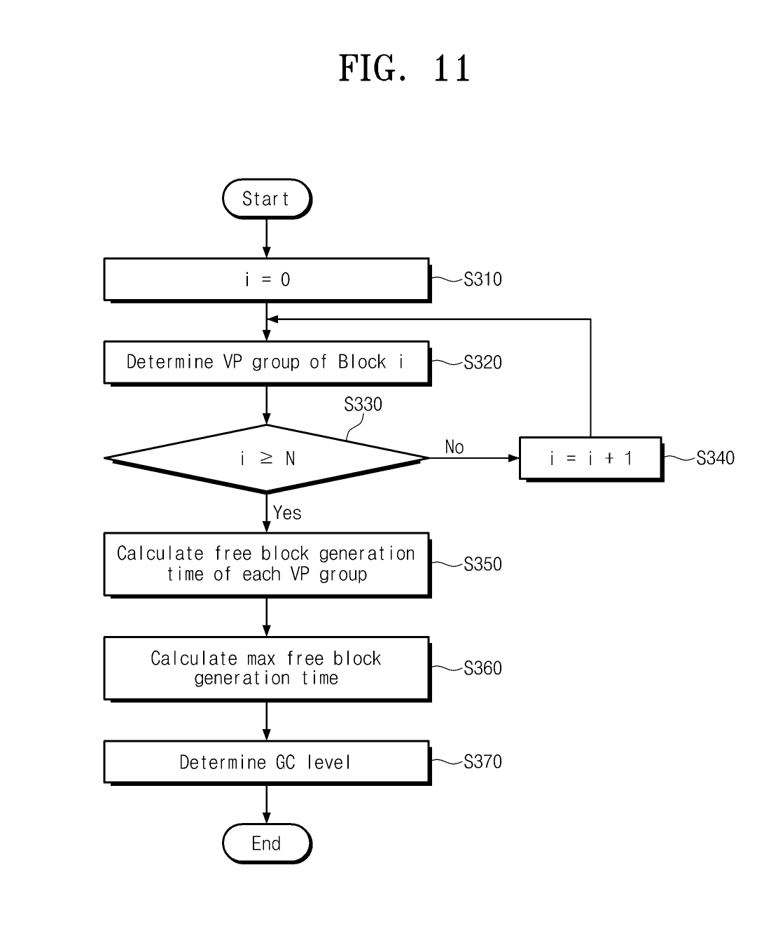

FIG. 10 and FIG. 11 are flowcharts illustrating operations of the garbage collection unit for generating the garbage collection level.

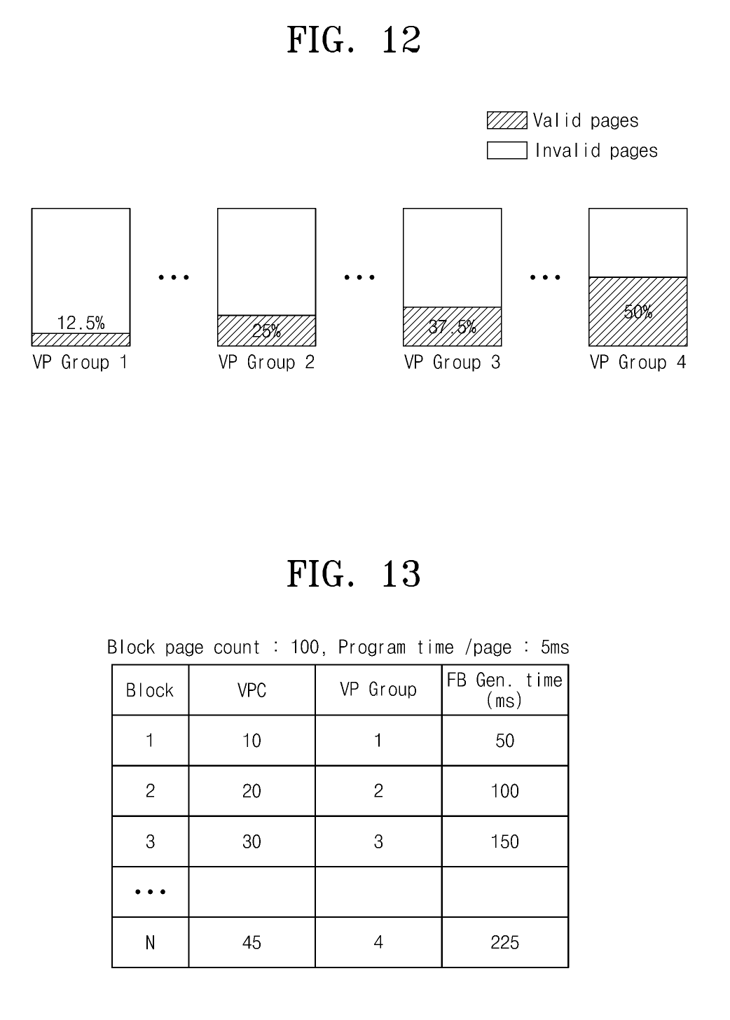

FIG. 10 is a flow chart illustrating an operation to generate the garbage collection level on the basis of an average free block generating time. Table 1, Table 2 and FIG. 12 are used to illustrate the garbage collection operation of FIG. 10 and FIG. 11.

For example, each page (or logical page) of the memory system 1000 is a program data unit when the memory device 1100 executes a program operation. If the memory device 1100 is SLC (Single Level Cell) storing one bit of data per cell, one logical page of data may be stored at one physical page (or word line). If the memory device 1100 is MLC (Multi Level Cell) storing at least two bits of data per cell, at least two logical pages of data may be stored at one physical page.

As used herein, the term “way” is used to refer to the number of memory devices 1100 to be operated at once when the memory controller 1200 executes a program operation. For example, if the way is 2, the memory controller 1200 executes a program operation for two memory devices 1100 at once. As used herein, the term “plane” refers to the number of blocks to be programmed at once in one memory device 1100. The number of logical pages to be programmed at one physical page is 1 when the memory device 1100 is SLC.

When the memory device 1100 is MLC storing 2 bits per cell, the number of logical pages to be programmed at one physical page is 2.

For concise description, it is assumed that the memory device 1100 includes 10 memory blocks (block0˜block9), and each block includes 100 pages. Also, it is assumed that the memory device 1100 is SLC, each physical page stores one logical page, the way of the memory system 1000 is 1 and the plane of the memory system 1000 is 1. However, according to example embodiments of the inventive concepts, memory system 1000 is not limited to these parameters.

Referring to FIGS. 9, 10 and 12, in step S120, the garbage collection unit 1250 initiates an operation of calculating the garbage collection level.

In step S210, the garbage collection unit 1250 initializes a value of i used in a process of calculating the garbage collection level to 0.

In step S220, the garbage collection unit 1250 determines valid page group properties of each memory blocks of the memory device 1100.

The garbage collection unit 1250 may determine the valid page group based on the predetermined valid page number or ratio. The valid page number of a memory block may represent, for example, a total number of valid pages in a memory block. The valid page ratio of a memory block may represent, for example, a ration of valid pages to invalid pages in a memory block.

Referring to the FIG. 12, the garbage collection unit 1250 may sort the memory block into the first valid page group (VP Group 1) if the valid page ratio of the memory block is less than 12.5%. The garbage collection unit 1250 may sort the memory block into the second valid page group (VP Group 2) if the valid page ratio of the memory block is more than 12.5% and less than 25%. The garbage collection unit 1250 may sort the memory block into the third valid page group (VP Group 3) if the valid page ratio of the memory block is more than 25% and less than 37.5%. The garbage collection unit 1250 may sort the memory block into the fourth valid page group (VP Group 4) if the valid page ratio of the memory block is more than 37.5% and less than 50%.

The garbage collection unit 1250 may check the number of valid pages of the block i to calculate the garbage collection level. If the number of valid pages of block i is 10 out of 100 total pages, the valid page ratio of block i is 10%. Because the valid page ratio of the block i is less than 12.5%, the garbage collection unit 1250 sorts the block i into the first valid page group. If the ratio of valid page of the block i is more than 50%, the garbage collection unit 1250 exclude the block i from garbage collection performing target.

In step S230, the garbage collection unit 1250 may determine whether a value of i is greater than or equal to N. N may be the total number of memory blocks included in the memory device 1100. For example, if the memory device 1100 includes 10 memory blocks, the value of N is 10. If the value of i is greater than or equal to N, the garbage collection unit 1250 executes step S250. If the value of i is less than N, the garbage collection unit 1250 executes step S240.

In step S240, the garbage collection unit 1250 increases the value of i by 1, and executes step S220 to determine valid page group of the next memory block. For example, if the value of i is 0, the garbage collection unit 1250 determines the valid page group of block 0 in step S220. If the value of i is changed to ‘1’ in step S240, the garbage collection unit 1250 executes step S220 to determine valid page group of block 1.

In step S250, the garbage collection unit 1250 may calculate free block generation times of each valid page group. For example, the maximum number of valid pages of memory blocks in the first valid page group, according to at least one example embodiment of the inventive concepts, is 12. The garbage collection unit 1250 may calculate free block generation time based on the maximum number of valid pages of the first valid page group.

Table 1 is an example result of the garbage collection unit 1250 calculating free block generation times of each valid page group. Referring to Table 1 and FIG. 12, the maximum valid page number of the first valid page group is N (N is integer). The maximum valid page number of the second valid page group may be 2N. The maximum valid page number of the third valid page group may be 3N. The maximum valid page number of the fourth valid page group may be 4N. According to one or more example embodiments, a formula for calculating free block generation time (tFB) of the each valid page group is in the following.

The value tFB=maximum valid page count/(way number*plane number*number of logical pages programmed per physical page)*program time per physical page.

TABLE 1

| VP | Max valid | Max page | FB Generation time |
|---|---|---|---|
| group | page ratio | count | (t: Program time per physical page) |
| 1 | 12.5% | N | N/(way*plane* logical page count per |
| | | | physical page)*t = T = tFB1 |
| 2 | 25% | 2N | 2N/(way*plane* logical page count per |
| | | | physical page)*t = 2T = tFB2 |
| 3 | 37.5% | 3N | 3N/(way*plane* logical page count per |
| | | | physical page)*t = 3T = tFB3 |
| 4 | 50% | 4N | 4N/(way*plane* logical page count per |
| | | | physical page)*t = 4T = tFB4 |

Still referring to Table 1, the free block generation time of the second valid page group (tFB2) is 2 times of the free block generation time of the first valid page group (tFB1). This is because the number of valid pages of the second valid page group is 2 times of the first valid page group. The free block generation time (tFB3) of the third valid page group is 3 times of the free block generation time of the first valid page group (tFB1). The free block generation time (tFB4) of the fourth valid page group is 4 times of the free block generation time of the first valid page group (tFB1).

In step S260, the garbage collection unit 1250 may calculate average free block generation time (tFBavg) of the memory device 1100 using free block generation times of the each valid page group calculated in step S250. The garbage collection unit 1250 totals up the free block generation times (tFB1˜tFB4) of the each of the valid page groups. Then, the garbage collection unit 1250 divides the totaled up value into the number of valid groups (referring to FIG. 12, the number of valid groups is 4). Thus, the garbage collection unit 1250 may generate the average free block generation time (tFBavg).

In step S270, the garbage collection unit 1250 determines a garbage collection level of the memory device (1100). Table 2 is illustrating garbage collection levels according to the trigger level.

TABLE 2

| GC level | Trigger level |
|---|---|
| 0 | A |
| 1 | B |
| 2 | C |
| 3 | D |

Referring to table 2, the garbage collection unit 1250 determines the garbage collection level based on the average free block generation time (tFBavg) generated at the step S260. The garbage collection unit 1250 compares the average free block generation time (tFBavg) with trigger levels of table 2. If the average free block generation time (tFBavg) is less than value of A, the garbage collection level of the memory device (1100) is ‘0’. Table 2 illustrates GC levels corresponding to tFBavg values that are equal to or below values A-D, respectively.

For example, according to one or more example embodiments of the inventive concepts, trigger values A-D may be set as follows: a trigger level A is 100 ms (milli-second), a trigger level B is 200 ms, a trigger level C is 300 ms, a trigger level D is 400 ms. Further, an example value for the average free block generation time (tFBavg) may be 150 ms. Because the average free block generation time of the memory device 1100 is longer than A and shorter than B, the garbage collection level of the memory device 1100 is ‘1’. If the average free block generation time is 350 ms, the garbage collection level of the memory device 1100 is ‘3’. Table 2 illustrates GC levels corresponding to tFBavg values that are equal to or below values A-D, respectively. However, according to one or more example embodiments of the inventive concepts, there may be more than 4 GC levels 0-3 corresponding to values A-D. For example, there may be a fifth GC level 4 corresponding to any tFBavg above 400 ms.

FIG. 11 is a flowchart illustrating an operation of garbage collection unit 1250 to generate the garbage collection level based on the maximum free block generation time.

In step S310, the garbage collection unit 1250 initializes an operation calculating the garbage collection level. The garbage collection unit 1250 initializes a value of parameter i to a value of, for example, 0.

In step S320, the garbage collection unit 1250 determines the valid page groups of the each memory blocks of the memory device 1100. The garbage collection unit 1250 may determine the valid page group of the each memory block based on predetermined valid page number or ratio. An operation of step S320 may be the same as that in S220 of FIG. 10, and description thereof is thus omitted.

In step S330, the garbage collection unit 1250 determines whether a value of i is greater than or equal to ‘N’. ‘N’ may be total number of memory blocks included in memory device 1100. For example, if the memory device 1100 includes 10 memory blocks, the value of N is 10. If the value of i is greater than or equal to N, the garbage collection unit 1250 executes step S350. If the value of i is less than N, the garbage collection unit 1250 executes step S340.

In step S340, the garbage collection unit 1250 increases the value of i by 1. Then the garbage collection unit 1250 executes S320 to determine valid page group of the next memory block. For example, if the value of i is 0, the garbage collection unit 1250 determines valid page group of memory block 0 in step S320. In step S340, if the value of i is changed to ‘ 1’, the garbage collection unit 1250 executes step S320 to determine valid page group of memory block 1.

In step S350, the garbage collection unit 1250 calculates free block generation time of each of the valid page groups. An operation of the step S350 may be the same as that in S250 of FIG. 10, and description thereof is thus omitted.

In step S360, garbage collection unit 1250 calculates a maximum free block generation time (tFBmax) of the memory device 1100 using the free block generation time (tFB) of each of the valid page groups calculated in step S350. When the garbage collection unit 1250 executes the garbage collection operation, the maximum number of generated free blocks may be maximum free block count. The garbage collection unit 1250 may calculate the maximum free block generation time (tFBmax) it takes to generate free blocks of maximum free block count with reference to the free block generation time and number of memory block of the each valid page group.

In step S370, the garbage collection unit 1250 may determine the garbage collection level (GC level) based on the maximum free block generation time (tFBmax) generated in step S360.

Referring to the table 2, the garbage collection unit 1250 compares the maximum free block generation time and trigger level of table 2. If the maximum free block generation time (tFBmax) is less than A, the garbage collection level (GC level) of the memory device 1100 is ‘0’. For example, according to one or more example embodiments of the inventive concepts, trigger values A-D may be set as follows: the trigger level of A is 300 ms, B is 500 ms, C is 700 ms, D is 900 ms, and the maximum free block generation time (tFBmax) is 450 ms. Because the maximum free block generation time of the memory device 1100 is longer than A, and shorter than B, the garbage collection level of the memory device 1100 is ‘1’. If the maximum free block generation time (tFBmax) is 800 ms, the garbage collection level is 4. Further, according to one or more example embodiments of the inventive concepts, there may be more than 4 GC levels 0-3 corresponding to values A-D. For example, there may be a fifth GC level 4 corresponding to any tFBavg above 900 ms.

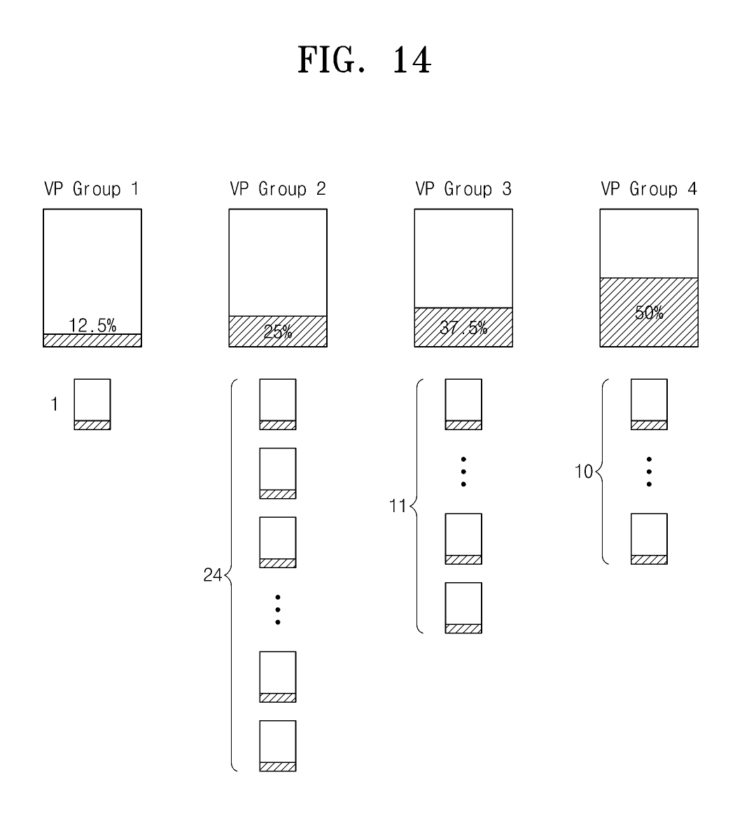

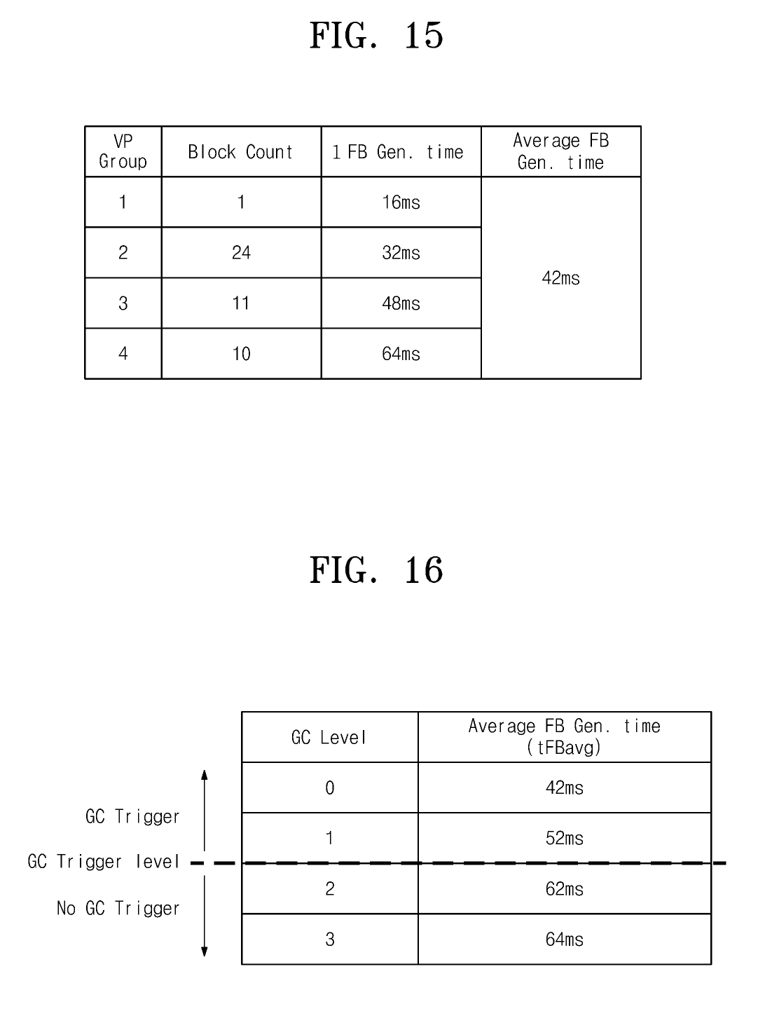

An operation of the memory system 1000 will be described in detail with reference to the FIG. 12 and FIG. 13.

FIG. 13 is a graph illustrating a composition of garbage collection information including valid page number, valid page group, and free block generation time of the each memory blocks. For concise description, FIGS.>12 and 13 will be described with reference to an example in which it is assumed that each memory block has 100 pages, and each page program time is 5 ms though, according to one or more example embodiments of the inventive concepts, different total page counts and page program times may be used.

Referring to FIG. 12 and FIG. 13, the first block includes 10 valid pages. The valid page ratio of the first block is 10%, and the first block is included in the first valid page group. When the garbage collection unit 1250 executes garbage collection operation regarding to the first block, the free block generation time is 10*5 ms=50 ms. In the example shown in FIG. 13, the number of valid pages of the second block is 20, and the valid page ratio of the second block is 20%. The second block is included in the second valid page group. The free block generation time of the second block is 20*5 ms=100 ms.

The number of valid page of the third block is 40, and the valid page ratio is 30%. The valid page ratio of the third block is greater than the maximum value of the second valid page group, and less than the maximum value of the third valid page group. The third block is included in the third valid page group. The number of valid pages of Nth block is 45, and the valid page ratio is 45%. The valid page ratio of the Nth block is greater than the maximum value of the third valid page group and less than the maximum value of the fourth valid page group. The Nth block is included in the fourth valid page group.

The garbage collection information including number of valid pages, valid page group, free block generation time of each blocks described in FIG. 13 may be stored in RAM (1240, FIG. 2) of the memory controller 1200.

FIG. 14, FIG. 15, and FIG. 16 illustrate the operation of the garbage collection unit of FIG. 2 and FIG. 3. Referring to the FIG. 14 through FIG. 16, the garbage collection operation according to the flowchart of FIG. 9 and FIG. 10 will be described. For example, there may be 46 garbage collection target blocks of the memory device 1100 of FIG. 4.

Referring to the FIG. 14, there is 1 block in the first valid page group because there is 1 block having a valid page ratio less than 12.5%. There are 24 blocks in the second valid page group because there are 24 block having a valid page ratio greater than 12.5% and less than 25%. There are 11 blocks in the third valid page group because there are 11 blocks having a valid page ratio greater than 25% and less than 37.5%. There are 10 blocks in the fourth valid page group because there are 10 blocks having a valid page ratio that is greater than 37.5% and less than 50%.

FIG. 15 is a diagram illustrating an example of the number of blocks and free block generation time of the each valid page groups of FIG. 14 and average free block generation time of the memory device 1100.

Referring to the FIG. 15, the first valid page group has 1 block. For example, it is assumed that the free block generation of the first valid page group (tFB1) is 16 ms. According to at least one example embodiment of the inventive concepts, the maximum number of valid pages of the second valid page group may be two times the maximum number of valid pages of the first valid page group. Thus, the free block generation time of the second valid page group (tFB2) is 32 ms. The maximum number of valid pages of the third valid page group is three times the maximum number of valid pages of the first page group such that the free block generation time of the third valid page group (tFB3) is 48 ms. The maximum number of valid pages of the fourth valid page group is four times the maximum number of valid pages of the first page group such that the free block generation time of the fourth valid page group (tFB4) is 64 ms.

Average free block generation time may be calculated based on the free block generation time of the each valid page groups and the number of memory blocks. Referring to the FIG. 15, the average free block generation time of the memory device 1100 is 42 ms.

FIG. 16 is a diagram illustrating garbage collections level of the memory system in FIG. 14 and the average free block generation time according to the garbage collection levels. Referring to FIG. 16, the memory system 1000 has a total 4 garbage collection levels.

A garbage collection trigger level may be a garbage collection level which is a criterion or, for example, a trigger for executing the garbage collection operation. The memory system 1000 may have a plurality of garbage collection levels to change garbage collection trigger level according to driven environment of the memory system 1000. The plurality of garbage collection levels may be stored at memory controller 1200 or the memory device 1100. For example, it is assumed that garbage collection trigger level of the memory system 1000 is 1. Thus, in the example illustrated in FIG. 16, the garbage collection unit 1250 executes the garbage collection operation when the garbage collection level is less than or equal to 1.

Returning to the illustrated example of FIG. 15, the average free block generation time (tFBavg) is 42 ms. Referring to FIG. 16, when the average free block generation time (tFBavg) is 42 ms, the garbage collection level is 0. Namely, the garbage collection trigger level of the memory system 1000 is 1, and the garbage collection level of the memory device 1100 is 0. The garbage collection unit 1250 executes garbage collection operation because the garbage collection level of the memory device 1100 is less than 1.

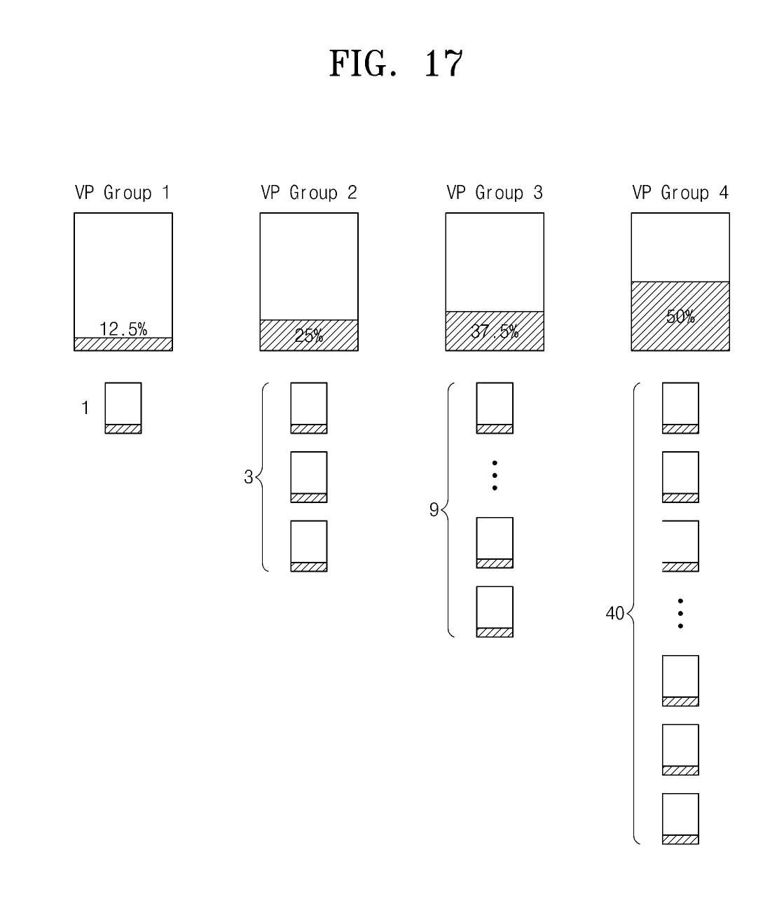

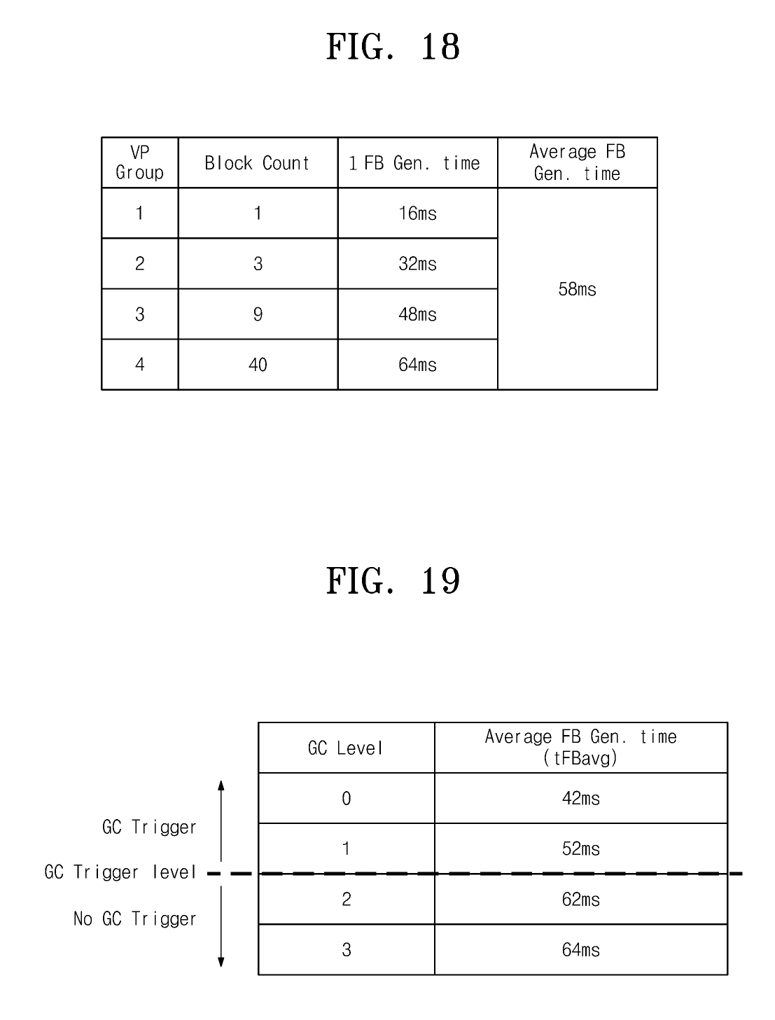

FIG. 17, FIG. 18 and FIG. 19 illustrate other example operations of the garbage collection unit in FIG. 2 and FIG. 3.

Referring to FIG. 17, in the example illustrated in FIG. 17, a total number of garbage collection target blocks of the memory device 1100 is 53. The first valid page group has 1 block. The second valid page group has 3 blocks. The third valid page group has 9 blocks. The fourth valid page group has 40 blocks.

Referring to FIG. 18, the first valid page group includes a block. The second valid page group includes 3 blocks. The third valid page group includes 9 blocks. The fourth valid page group includes 40 blocks. The garbage collection unit 1250 generates the average free block generation time based on the free block generation times and the number of memory blocks of the each valid page groups. Referring to the FIG. 18, the average free block generation time of the memory device 1100 is 58 ms.

Referring to FIG. 19, the garbage collection trigger level of the memory system 1000 is 1. As will be appreciated from the above description of FIG. 18, the average free block generation time (tFBavg) of the memory device 1100 is 58 ms. Thus, in the example illustrated in FIG. 19, the garbage collection level is 2. Namely, the garbage collection trigger level of the memory system 1000 is 1, and the garbage collection level of the memory device 1100 is 2. The garbage collection unit 1250 does not execute garbage collection operation because the garbage collection level of the memory device 1100 is greater than 1.

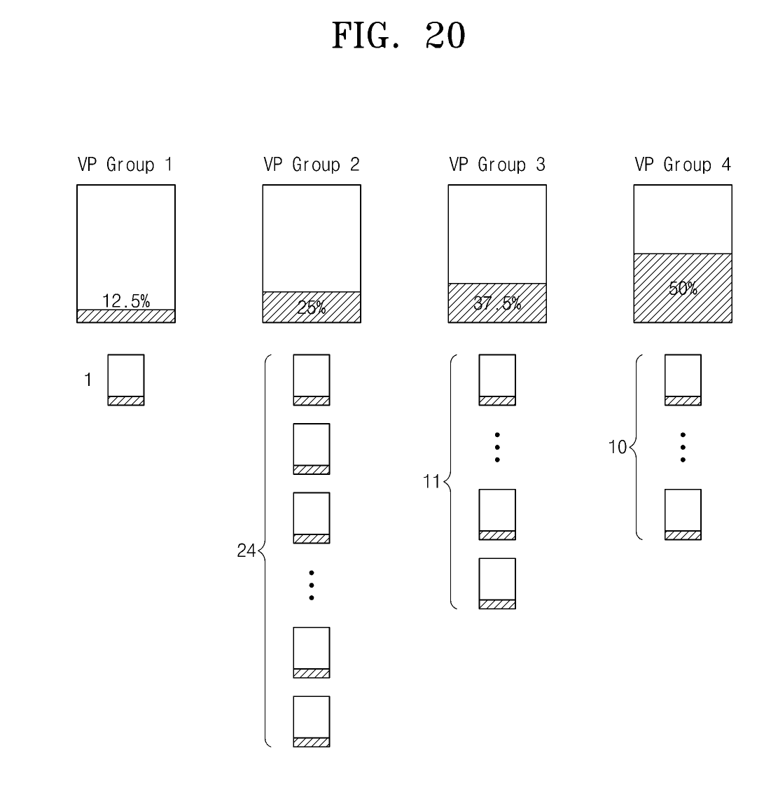

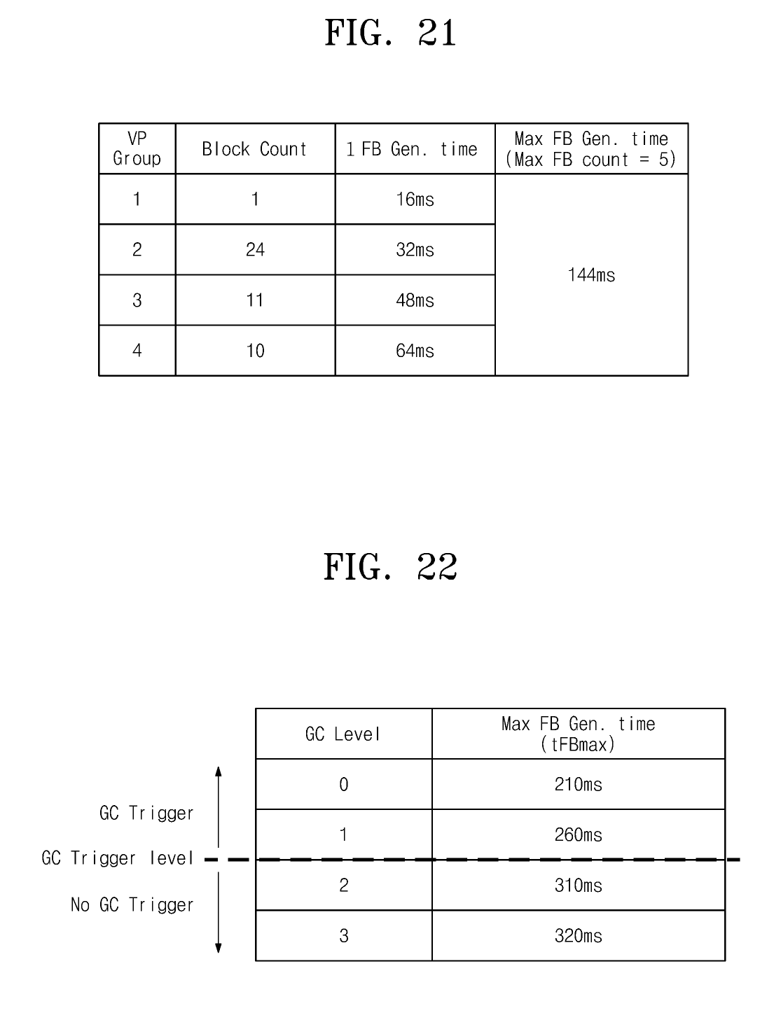

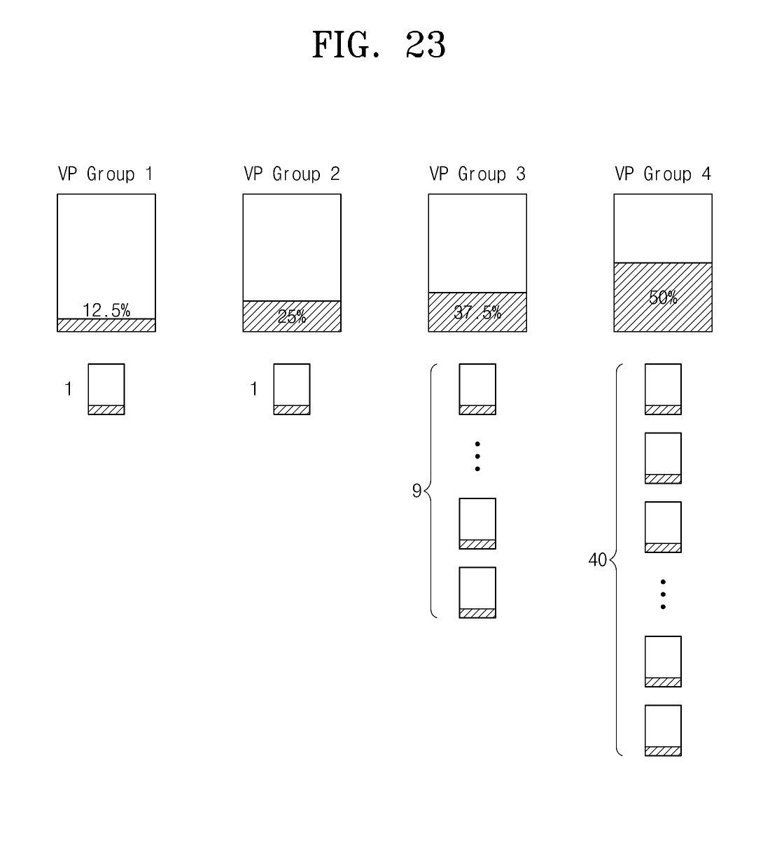

FIG. 20, FIG. 21, and FIG. 22 illustrate other example operations of the garbage collection unit of FIG. 2 and FIG. 3. The garbage collection operation according to the flowchart of FIG. 9 and FIG. 11 will be described in detail by referring to the FIG. 20 to FIG. 22.

Referring to FIG. 20, a total number of the garbage collection target blocks of the memory device 1100 is 46. The first valid page group includes a block. The second valid page group includes 24 blocks. The third valid page group includes 11 blocks. The fourth valid page group includes 10 blocks.

FIG. 21 is a diagram illustrating the number of blocks and free block generation times of each valid page groups, and the maximum free block generation time of the memory device 1100.

Referring to FIG. 21, the garbage collection unit 1250 may generate the maximum free block generation time of the memory device 1100 based on the free block generation time and the number of memory blocks of the each valid page groups. The maximum free block generation time is a time taking to generate free blocks of the maximum free block count.

In the example shown in FIG. 21, it is assumed that the maximum free block count is 5. The garbage collection unit 1250 may generate maximum 5 free blocks. The garbage collection unit 1250 generates 5 free blocks using 1 block of the first valid page group and 4 blocks of the second valid page group. Herein, the maximum free block generation time (tFBmax) of the memory device 1100 is 16 ms+32 ms×4=144 ms. According to at least one example embodiment of the inventive concepts, the blocks used to calculate tFBmax are chosen in numerical order based on valid page group (i.e., block(s) from the first valid page group are chosen before blocks(s) from the second valid page group; blocks(s) from the second valid page group are chosen before blocks from the third valid page group; etc.).

FIG. 22 is a diagram illustrating an example of the garbage collection level of the memory system of FIG. 20 and the maximum free block generation time. Referring to FIG. 22, the memory system 1000 has total 4 garbage collection levels. For example, in the example shown in FIG. 22, it is assumed that the garbage collection trigger level of the memory system 1000 is 1. In other words, the garbage collection unit 1250 executes the garbage collection operation when the garbage collection level is less than or equal to 1.

As will be appreciated from the above description of FIG. 21, the maximum free block generation time (tFBmax) of the memory device 1100 is 144 ms. Referring to FIG. 22, the garbage collection level is 0. The garbage collection trigger level of the memory system 1000 is 1 and the garbage collection level of the memory device 1100 is 0. The garbage collection unit 1250 executes the garbage collection operation because the garbage collection level of the memory device is less than 1.

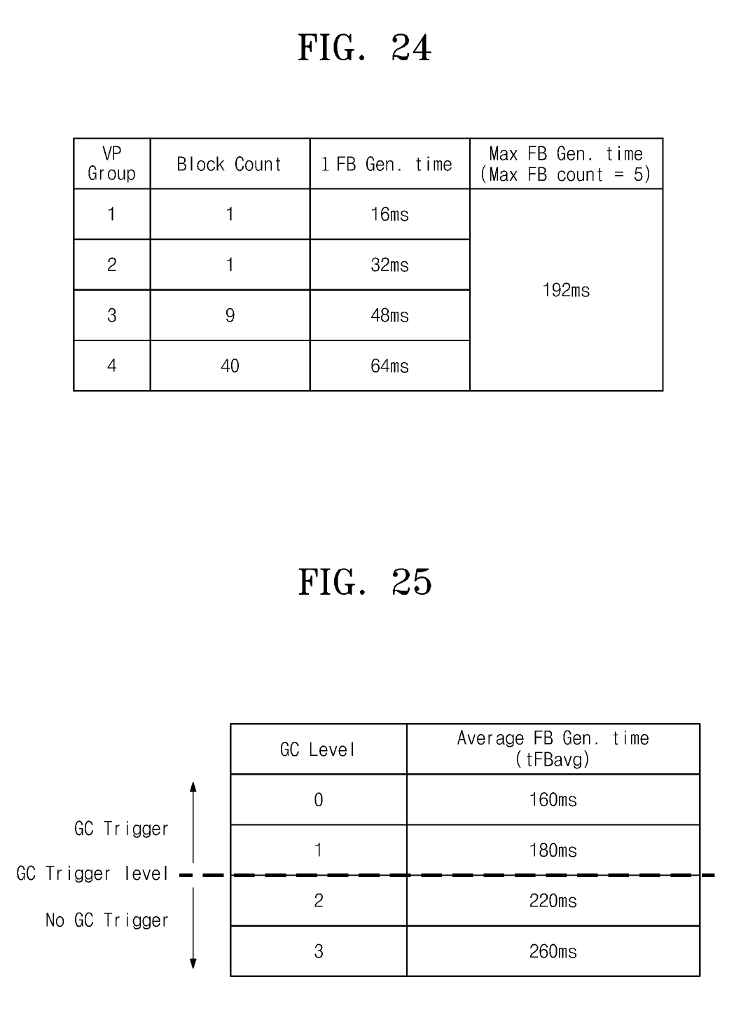

FIG. 23 to FIG. 25 are diagrams illustrating operations of the garbage collection unit of FIG. 2 and FIG. 3. Referring to FIG. 23, a total number of the garbage collection target blocks of the memory device 1100 is 51. There is one block belonging to the first valid page group. There is 1 block belonging to the second valid page group. There are 9 blocks belonging to the third valid page group. There are 40 blocks belonging to the fourth valid page group.

Referring to FIG. 24, it is assumed that the maximum free block count is 5. The garbage collection unit 1250 generates maximum 5 free blocks. The garbage collection unit 1250 generates total 5 free blocks using 1 block belonging to the first valid page group, 1 block belonging to the second valid page group, and 3 blocks belonging to the third valid page group. Here, the maximum free block generation time (tFBmax) of the memory device 1100 is 192 ms.

Referring to FIG. 25, because the maximum free block generation time (tFBmax) of the memory device 1100 is 192 ms, the garbage collection level is 2. The garbage collection trigger level of the memory system 1000 is 1 and the garbage collection level of the memory device is 2. The garbage collection unit 1250 does not execute garbage collection operation because the garbage collection level of the memory device 1100 is greater than 1.

### III. Example Embodiment

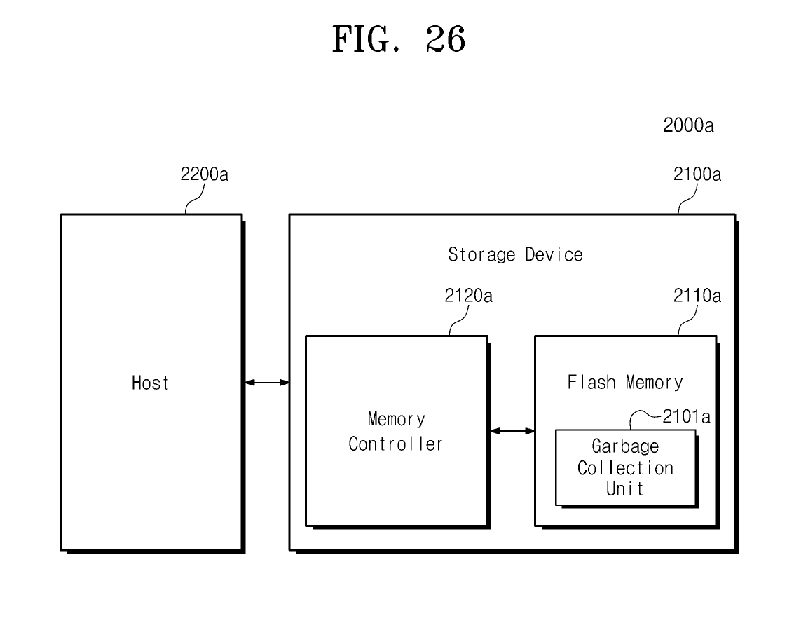

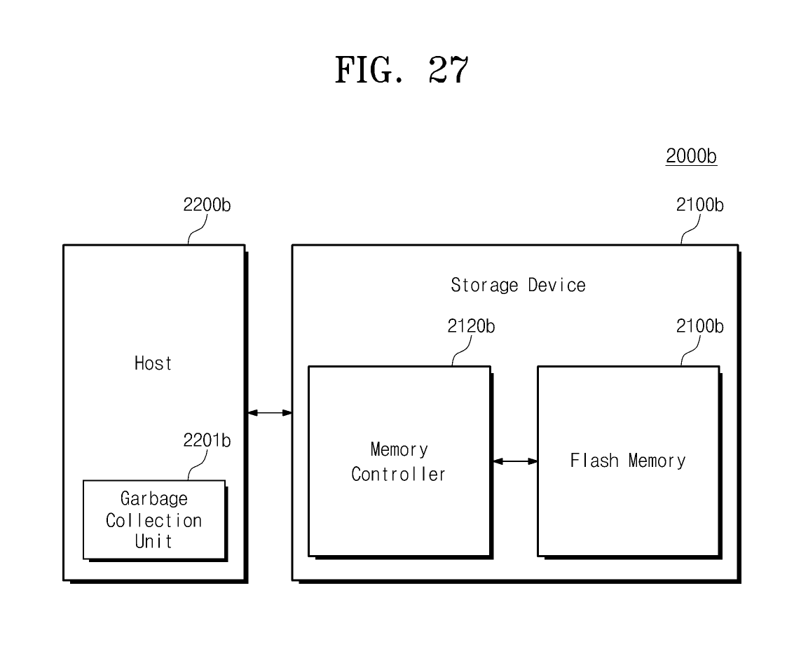

FIG. 26 and FIG. 27 are block diagrams respectively illustrating example applications of a memory system according to at least one example embodiment of the inventive concepts. Referring to FIGS. 26 and 27, a memory system 2000a, 2000b comprises a storage device 2100a, 2100b, and a host 2200a, 2200b. The storage device 2100a, 2100b may include a flash memory 2100a, 2100b and a memory controller 2120a, 2120b.

The storage device 2100a, 2100b may include a storage medium such as a memory card (e.g., SD, MMC, etc.) or an attachable handheld storage device (e.g., an USB memory). The storage device 2100a, 2100b may be connected with the host 2200a, 2200b. The storage device 2100a, 2100b may transmit and receive data to and from the host via a host interface. The storage device 2100a, 2100b may be supplied with a power from the host 2200a, 2200b.

Referring to FIG. 26, a garbage collection unit 2101a may be included in a flash memory 2110a, and referring to FIG. 27, a garbage collection unit 2201b may be included in a host 2200b. According to one or more example embodiments of the inventive concepts, the garbage collection units 2101a and 2201b may have the same operation and/or structure as that garbage collection unit 1250 described above with reference to FIGS. 1-26. Memory systems 2000a, 2000b according to at least some embodiments of the inventive concepts may improve response time of the read operation and write operation in the idle time of memory device using the garbage collection unit 2101a, 2201b.

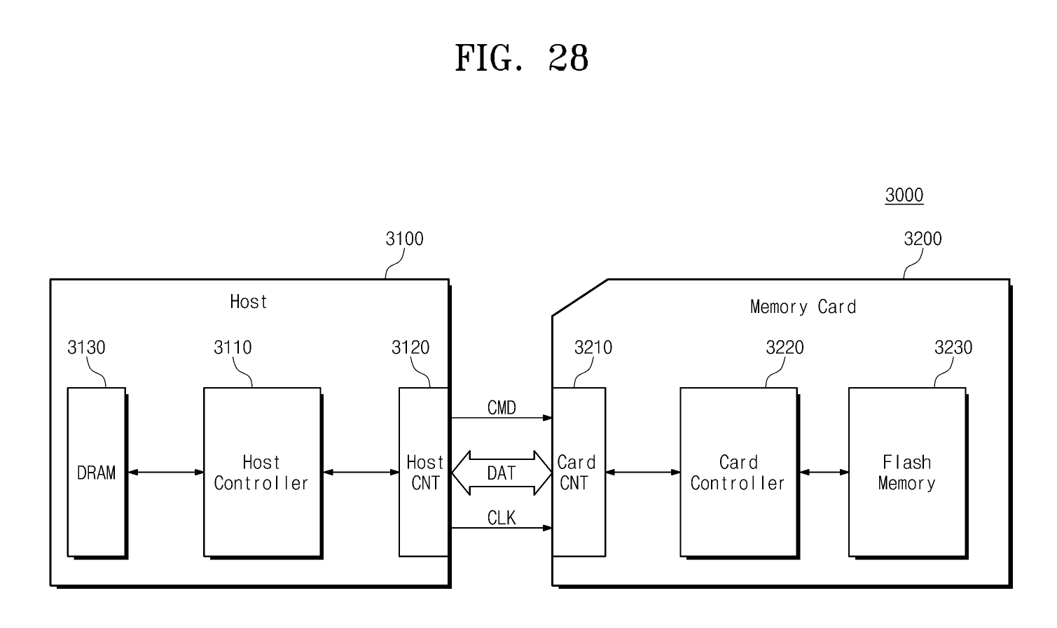

FIG. 28 is a block diagram illustrating a memory card system 3000 that may incorporate a memory system according to at least one example embodiment of the inventive concepts. The memory card system 3000 includes a host 3100 and a memory card 3200. The host 3100 includes a host controller 3110, a host connection unit 3120, and DRAM 3130. According to one or more example embodiments of the inventive concepts, at least one of the host 3100 and the memory card 3200 may include a garbage collection unit having the same operation and/or structure as that garbage collection unit 1250 described above with reference to FIGS. 1-26.

The host 3100 may write data in the memory card 3200 and read data from the memory card 3200. The host controller 3100 may send a command (e.g., a write command), a clock signal CLK generated by a clock generator (not shown), and corresponding write data to the memory card 3200 via the host connection unit 3120. The DRAM 3130 may be used as a main memory by the host 3100.

The memory card 3200 may include a card connection unit 3210, a card controller 3220, and a flash memory 3230. The card controller 3220 may store data in the flash memory 3230 in response to a command input via the card connection unit 3210. The data may be stored synchronously with respect to the clock signal generated by a clock generator (not shown) in the card controller 3220. The flash memory 3230 may store data transferred from the host 3100. For example, in a case where the host 3100 is a digital camera, the flash memory 3230 may store image data.

A memory card system 3000 illustrated in FIG. 28 may include a garbage collection unit in the host controller 3100, card controller 3220, or the flash memory 3230. As described above, at least some embodiments of the inventive concepts including the use of a garbage collection unit will reduce response time of read operation and write operation by adaptively executing garbage collection operation in the idle time.

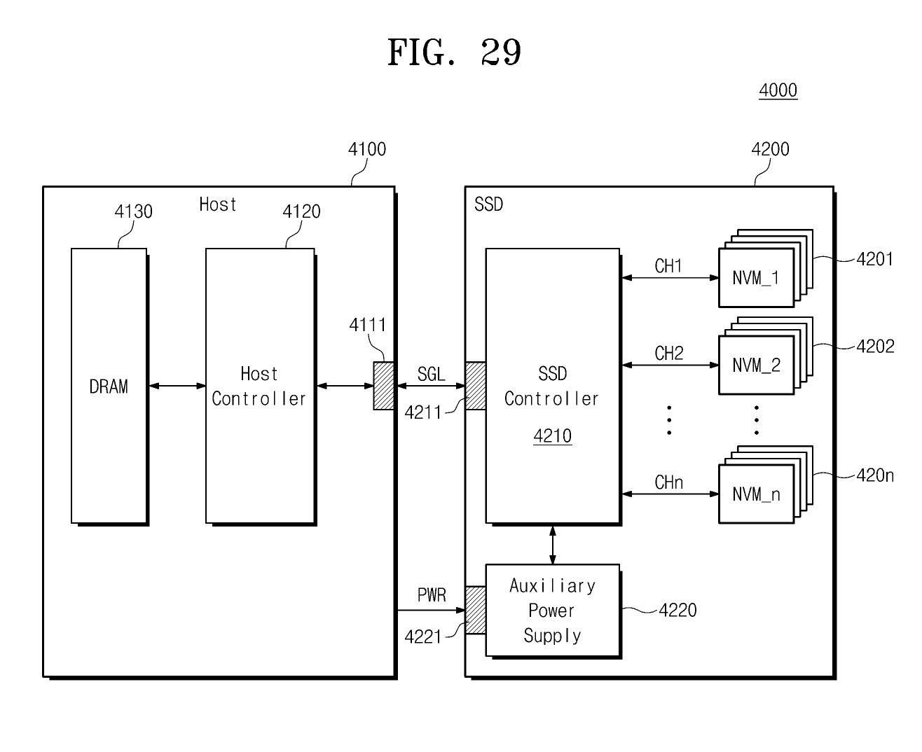

FIG. 29 is a block diagram illustrating a solid state drive (SSD) system including a memory system according to at least one example embodiment of the inventive concepts. Referring to FIG. 29, a SSD system 4000 generally includes a host 4100, and an SSD 4200. The host 4100 includes a host interface 4111, a host controller 4120, and a DRAM 4130. According to one or more example embodiments of the inventive concepts, at least one of the host 4100 and the SSD 4200 may include a garbage collection unit having the same operation and/or structure as that garbage collection unit 1250 described above with reference to FIGS. 1-26.

The host 4100 may be used to write data to the SSD 4200, and to read data from the SSD 4200. The host controller 4120 may be used to transfer signals (SGL) such as command(s), address(es), and/or control signal(s) to the SSD 4200 via the host interface 4111. The DRAM 4130 may be used to as main memory of the host 4100.

The SSD 4200 may be configured to exchange SGL signals with the host 4100 via the host interface 4211, and may also be configured to receive power via a power connector 4221. The SSD 4200 includes a plurality if nonvolatile memories 4201 to 420n, an SSD controller 4210, and an auxiliary power supply 4220. Herein, the nonvolatile memories 4201 to 420n may be implemented using not only one or more flash memory devices, but also PRAM, MRAM, ReRAM, etc.

The plurality of nonvolatile memories 4201 to 420n may be used as the storage medium of SSD 4200. The plurality of nonvolatile memories 4201 to 420n may be connected with the SSD controller 4210 via a plurality of channels, CH1 to CHn. One channel may be connected with one or more nonvolatile memories. Nonvolatile memories connected with one channel may be connected with the same data bus.

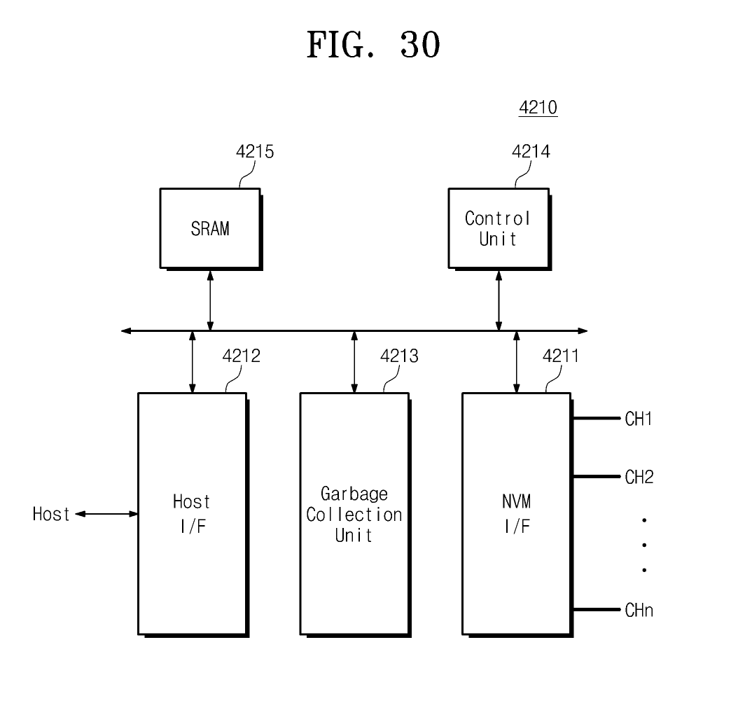

The SSD controller 4210 may exchange signals SGL with the host 4100 via the host interface 4211. Herein, the signals SGL may include a command, an address, data, and the like. The SSD controller 4210 may be configured to write or read out data to or from a corresponding nonvolatile memory according to a command of the host 4100. The SSD controller 4210 will be more fully described with reference to FIG. 30.

The auxiliary power supply 4220 may be connected with the host 4100 via the power connector 4221. The auxiliary power supply 4220 may be changed by a power PWR from the host 4100. The auxiliary power supply 4220 may be placed within the SSD 4200 or outside the SSD. For example, the auxiliary power supply 4220 may be disposed on a main board to supply an auxiliary power to the SSD 4200.

FIG. 30 is a block diagram further illustrating the SSD controller 4210 of FIG. 29. Referring to FIG. 30, the SSD controller 4210 comprises a nonvolatile memory (NVM) interface 4211, a host interface 4212, a garbage collection unit 4213, control unit 4214, and an SRAM 4215. According to one or more example embodiments of the inventive concepts, the garbage collection unit 4213 may have the same operation and/or structure as that garbage collection unit 1250 described above with reference to FIGS. 1-26.

The NVM interface 4211 may scatter data transferred from a main memory of a host 4100 to channels CH1 to CHn, respectively. The NVM interface 4211 may transfer data read from nonvolatile memories 4201 to 420n to the host 4100 via the host interface 4212.

The host interface 4212 may provide an interface with an SSD 4200 according to the protocol of the host 4100. The host interface 4212 may communicate with the host 4100 suing USB, SCSI, PCI, PCI-E, ATA, parallel ATA, serial ATA, SAS, etc. The host interface 4212 may perform a disk emulation function which enables the host 4100 to recognize the SSD 4200 as a hard disk drive (HDD).

The garbage collection unit 4213 may be used to manage the execution of a garbage collection operation in relation to the nonvolatile memories 4201 to 420n, as described above. The control unit 4214 may be used to analyze and process signals SGL input from the host 4100. The control unit 4214 may be used to control the host 4100 via the host interface 4212 or the nonvolatile memories 4201 to 420n via the NVM interface 4211. The control unit 4214 may control the nonvolatile memories 4201 to 420n using firmware that drives at least in part the operation of SSD 4200.

The SRAM 4215 may be used to drive software which efficiently manages the nonvolatile memories 4201 to 420n. The SRAM 4215 may store metadata input from a main memory of the host 4100 or cache data. At a sudden power-off operation, metadata or cache data stored in the SRAM 4215 may be stored in the nonvolatile memories 4201 to 420n using an auxiliary power supply 4220.

Returning to FIG. 30, the SSD system 4000 incorporating techniques consistent with at least some example embodiments of the inventive concepts may reduce the response time of read operation and write operation in idle time by executing garbage collection operation using the garbage collection unit of the memory system as described above.

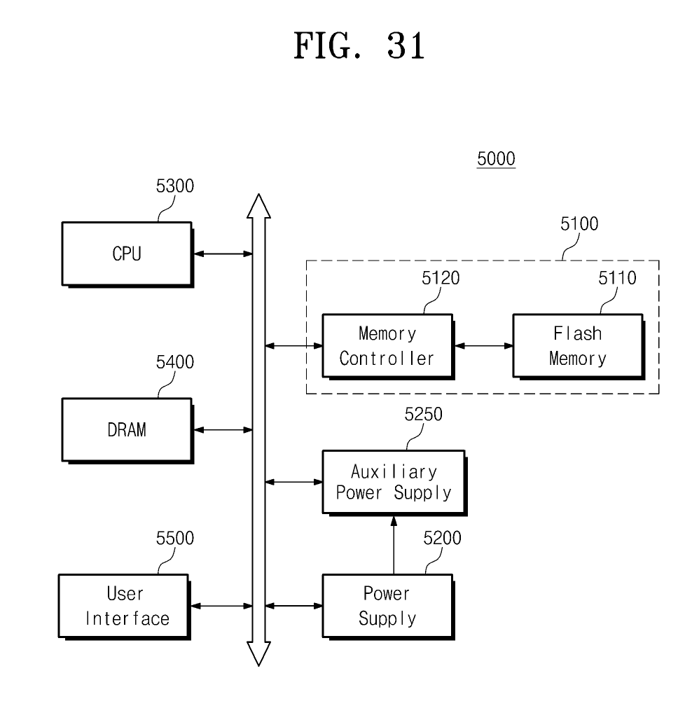

FIG. 31 is a block diagram illustrating an electronic device that may incorporate a memory system according to at least one example embodiment of the inventive concepts. Herein, an electronic device 5000 may be a personal computer (PC) handheld electronic device such as a notebook computer, a cellular phone, a personal digital assistant (PDA), a digital camera, etc.

Referring to FIG. 31, the electronic device 5000 generally comprises a memory system 5100, a power supply device 5200, an auxiliary power supply 5250, a central processing unit (CPU) 5300, a DRAM 5400, and a user interface 5500. The memory system 5100 may be embedded within the electronic device 5000. According to one or more example embodiments of the inventive concepts, the memory system 5100 may include a garbage collection unit having the same operation and/or structure as that garbage collection unit 1250 described above with reference to FIGS. 1-26.

As described above, by incorporating a memory system according to at least one example embodiment of the inventive concepts, the electronic device 5000 may improve response time of read operation and write operation by adaptively executing the garbage collection operation in idle time using garbage collection unit of the memory system.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A memory system comprising:
a nonvolatile memory including a plurality of memory blocks; and
a memory controller including a garbage collection unit,
the garbage collection unit configured to generate a garbage collection level,
the garbage collection unit configured to perform a garbage collection operation based on the garbage collection level and a garbage collection trigger level, and
the garbage collection level being generated based on a free block generation time of the nonvolatile memory.

2. The memory system of claim 1, wherein
the free block generation time of the nonvolatile memory is an average free block generation time or a maximum free block generation time.

3. The memory system of claim 2, wherein
the memory controller is configured to determine a valid page group of each of the plurality of memory blocks according to a number of valid pages of each of the plurality of the memory blocks,
the memory controller is configured to determine free block generation times of at least two of the valid page groups, and
the memory controller is configured to generate the garbage collection level based on the determined free block generation times.

4. The memory system of claim 3, wherein
the memory controller is configured to determine the average free block generation time based on the free block generation times of each of the valid page groups, and
the memory controller is configured to determine the garbage collection level of the nonvolatile memory using the determine average free block generation time.

5. The memory system of claim 4, wherein the memory controller comprises: a random access memory (RAM) unit,
the memory controller being configured to store, in the RAM unit,
the number of valid pages of each of the plurality of memory blocks,
the valid page group of each of the plurality of the memory blocks,
the average free block generation time of the nonvolatile memory, and
the garbage collection level of the nonvolatile memory.

6. The memory system of claim 3 wherein,
the memory controller is configured to determine the maximum free block generation time using the free block generation times of each of the at least two of the valid page groups, and
the memory controller is configured to determine the garbage collection level of the nonvolatile memory based on the determined maximum free block generation time,
the maximum free block generation time indicates a length of time for generating free blocks of a maximum free block count.

7. The memory system of claim 6 wherein,
the memory controller is configured to store,
the valid page group each of the plurality of memory blocks,
the number of valid pages of each of the plurality of memory blocks,
the memory controller is configured to store the maximum free block generation time of the nonvolatile memory, and
the garbage collection level of the nonvolatile memory.

8. The memory system of claim 2, wherein
the garbage collection unit is configured to generate one or more free blocks by performing the garbage collection operation,
the garbage collection unit is configured to change a value of a free block count based on a total number of the generated one or more free blocks, and
the garbage collection unit is configured to terminate the garbage collection operation based on the changed value of the free block count and a maximum free block count.

9. The memory system of claim 8, wherein
the garbage collection unit is configured to terminate the garbage collection operation in response to determining that the changed value of the free block count is greater than or equal to the maximum free block count.

10. The memory system of claim 1, wherein
the garbage collection unit is configured to generate the garbage collection level in response to determining that idle time of the nonvolatile memory is greater than a reference idle time.

11. The memory system of claim 1, wherein
the garbage collection unit is configured to generate the garbage collection level if data storage space is below a reference storage space level.

12. A memory system comprising:
a nonvolatile memory including a plurality of memory blocks; and
a memory controller including a garbage collection unit,
the garbage collection unit being configured to,
select, from among a plurality of garbage collection levels, a garbage collection level of the nonvolatile memory based on free block generation times of the plurality of blocks, the free block generation times indicating time lengths of free block generation operations for generating free blocks among the plurality of memory blocks, and
determine whether or not to perform a garbage collection operation on the nonvolatile memory based on the selected garbage collection level and a garbage collection trigger level.

13. The memory system of claim 12 wherein,
the plurality of garbage collection levels correspond, respectively, with a plurality of threshold times, and
the garbage collection unit is configured to select the garbage collection level of the nonvolatile memory by,
determining an average free block generation time based on the free block generation times of the plurality of blocks, and
selecting the garbage collection level of the nonvolatile memory, from among the plurality of garbage collection levels,
based on the average free block generation time and the plurality of threshold times.

14. The memory system of claim 13, wherein the garbage collection unit is configured to determine the average free block generation time as an average amount of time to generate one free block among the plurality of memory blocks.

15. The memory system of claim 13, wherein the garbage collection unit is configured to determine the average free block generation time as an average amount of time to generate n free blocks among the plurality of memory blocks,
n being a positive integer equal to a maximum free block number of the memory system,
the maximum free block number being a maximum number of free blocks the memory system is capable of generating in a garbage collection operation.
